(19) United States
(12) Patent Application Publication
(10) Pub. No.: US 2026/0327380 A1
(43) Pub. Date: Oct. 22, 2026

(54) SILYL CARBAMATES AND POLY(SILYL CARBAMATES) AND USES THEREOF

(71) Applicant: Massachusetts Institute of Technology, Cambridge, MA (US)

(72) Inventors: Valerie Lensch, Boston, MA (US); Jermiah A. Johnson, Boston, MA (US); Keith Husted, Boston, MA (US)

(73) Assignee: Massachusetts Institute of Technology, Cambridge, MA (US)

(21) Appl. No.: 19/105,451

(22) PCT Filed: Aug. 23, 2023
(86) PCT No.: PCT/US2023/072768

§ 371 Date: Feb. 21, 2025

Related U.S. Application Data
(60) Provisional application No. 63/400,731, filed on Aug. 24, 2022.

(51) Int. Cl. C08G 77/62; C08G 77/00; C08J 11/28

(52) U.S. Cl. CPC C08G 77/62; C08J 11/28; C08G 77/80

(57) ABSTRACT

The present disclosure provides polymers comprising n12 instances of a moiety of Formula (I): or a salt thereof. The present disclosure also provides methods of preparing the polymers and degrading the polymers. Contacting the polymers with a fluoride nucleophile (e.g., tetrabutylammonium fluoride) or acid (e.g. octanoic acid) may degrade the polymers by cleaving the O—Si bonds. The polymers may be useful as degradable polymers, adhesives, coatings, elastomers, sealants, flexible foams, or structural materials.

### RELATED APPLICATIONS

The present application claims priority under 35 U.S.C. § 119(e) to U.S. Provisional Patent Application No. 63/400,731, filed Aug. 24, 2022, which is incorporated herein by reference.

### BACKGROUND OF THE DISCLOSURE

There is a need to improve the reprocessability of thermosets, which may be hindered by chemical crosslinking within the thermosets. For example, polyurethanes (PUs) are a highly diverse class of valuable thermosets, with variability in polymer stiffness ranging from flexible elastomers to rigid, high-performance materials. The properties of a polyurethane are largely determined by whether they are aromatic (e.g., derived from diphenylmethane diisocyanate (MDI), toluene diisocyanate (TDI), naphthalene diisocyanate (NDI)) or aliphatic/alkyl (e.g., derived from hexamethylene diisocyanate (HDI), isophorone diisocyanate (IPDI), hydrogenated MDI). Certain aromatic polyurethanes may be recycled by glycolysis, which breaks down aryl PUs into reusable components, or through catalysis of aryl PU exchange. However, alkyl PUs cannot be readily recycled, because they decompose into difficult-to-use products such as primary amines, carbon dioxide, and terminal alkenes. Alkyl PUs are used for certain high-performance applications that demand greater thermal and photostability, and optical clarity, but these materials cannot be reprocessed, as they decompose at the higher temperatures required to induce exchange of the less reversible alkyl carbamate linkages. Pyrolysis may be difficult and energy intensive for crosslinked materials. Depolymerization of the urethane linkages at elevated temperatures or solvolysis (e.g., hydrolysis) may yield recovered products with limited purity. See, Gama et al., Materials, 2018, 11, 1-35; Fortman et al., ACS Sustain. Chem. Eng., 2018, 6, 11145-11159. Attempts to degrade polyurethanes are reported in Babra et al., Polym. Chem., 2017, 8, 7207-7216; Zhang et al., ACS Macro Lett., 2022, 11, 868-874; Sheppard et al., ACS Cent. Sci., 2020, 6, 921-927; and Morado et al., Nat. Chem., 2023, 15, 569-577. There is a need for improved degradable polyurethanes.

### SUMMARY OF THE DISCLOSURE

An approach to convert existing thermosets into degradable variants would involve the use of a low-cost co-monomer additive that, when introduced at low levels during standard thermoset formulation conditions, could introduce cleavable bonds at precise locations within the thermoset polymer network enabling material degradation with otherwise little to no impact on properties. The use of such co-monomer strategies to imbue commodity polymers with degradability or reprocessability is rare, and would allow for the development of degradable PUs (e.g., degradable alkyl PUs).

The present disclosure provides a polymer wherein the polymer comprises n12 instances of a moiety of Formula (I):

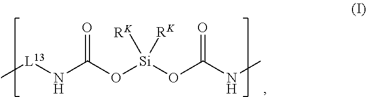

or a salt thereof, wherein:
each instance of R^{K} is independently hydrogen, halogen, substituted or unsubstituted, C₁₋₁₀ alkyl, substituted or unsubstituted, C₂₋₁₀ alkenyl, substituted or unsubstituted, C₂₋₁₀ alkynyl, -L^{K}-(substituted or unsubstituted carbocyclyl), -L^{K}-(substituted or unsubstituted heterocyclyl), -L^{K}-(substituted or unsubstituted aryl), -L^{K}-(substituted or unsubstituted heteroaryl), or —OR^{N};
each instance of L^{K} is independently a single bond, —O—, substituted or unsubstituted, C₁₋₁₀ alkylene, substituted or unsubstituted, C₂₋₁₀ heteroalkylene, substituted or unsubstituted carbocyclylene, substituted or unsubstituted heterocyclylene, substituted or unsubstituted arylene, substituted or unsubstituted heteroarylene, or a combination thereof;
each instance of R^{N} is independently hydrogen, substituted or unsubstituted acyl, substituted or unsubstituted, C₁₋₁₀ alkyl, substituted or unsubstituted carbocyclyl, substituted or unsubstituted heterocyclyl, substituted or unsubstituted aryl, substituted or unsubstituted heteroaryl, or an oxygen protecting group;
or two instances of R^{K} are joined with the intervening atom to form substituted or unsubstituted heterocyclyl; each instance of L¹³ is a linker, wherein no instance of the linker is a bond or unsubstituted naphthalene diradical; and
n12 is an integer between 1 and 1,000, inclusive.

The polymers may be generated via step-growth polymerization of silanediols with diisocyanates. This strategy may imbue degradability into polymer (e.g., polyurethane) thermosets.

The present disclosure also provides a method of preparing a polymer comprising reacting:
one or more instances of a silane polyol, wherein each instance of the silane polyol is of Formula (A):

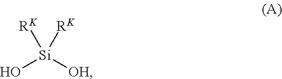

or a salt thereof; and
one or more instances of a polyisocyanate, wherein each instance of the polyisocyanate is of Formula (B):

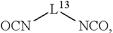

or a salt thereof;
optionally: the step of reacting comprises polymerizing one or more instances of the silane polyol, one or more instances of the polyisocyanate, and optionally one or more instances of a third monomer;
   wherein:
each instance of R^{K} is independently hydrogen, halogen, substituted or unsubstituted, C₁₋₁₀ alkyl, substituted or unsubstituted, C₂₋₁₀ alkenyl, substituted or unsubstituted, C₂₋₁₀ alkynyl, -L^{K}-(substituted or unsubstituted carbocyclyl), -L^{K}-(substituted or unsubstituted heterocyclyl), -L^{K}-(substituted or unsubstituted aryl), -L^{K}-(substituted or unsubstituted heteroaryl), or —OR^{N};
each instance of L^{K} is independently a single bond, —O—, substituted or unsubstituted, C₁₋₁₀ alkylene, substituted or unsubstituted, C₂₋₁₀ heteroalkylene, substituted or unsubstituted carbocyclylene, substituted or unsubstituted heterocyclylene, substituted or unsubstituted arylene, substituted or unsubstituted heteroarylene, or a combination thereof;
each instance of R^{N} is independently hydrogen, substituted or unsubstituted acyl, substituted or unsubstituted, C₁₋₁₀ alkyl, substituted or unsubstituted carbocyclyl, substituted or unsubstituted heterocyclyl, substituted or unsubstituted aryl, substituted or unsubstituted heteroaryl, or an oxygen protecting group;
or two instances of R^{K} are joined with the intervening atom to form substituted or unsubstituted heterocyclyl; and
each instance of L¹³ is independently a linker, wherein no instance of the linker is a bond or unsubstituted naphthalene diradical.

The provided polymers may be prepared by reacting the silane polyol and the polyisocyanate in the absence or presence of a third monomer. The third monomer may be used to alter the properties of the polymers.

Contacting the polymers with a fluoride source (e.g., fluoride nucleophile) or acid (e.g. octanoic acid) may degrade the polymers by, e.g., cleaving the silyl carbamate (e.g., at O—Si) bonds. See Sutyak et al., ACS Appl. Mater. Interfaces, 2022, 14, 22407-22417; Jacquemard et al., Tetrahedron, 2004, 60, 10039-10047.

In another aspect, the present disclosure provides a method of degrading a polymer described herein comprising reacting the polymer with an acid or fluoride source under suitable conditions.

The polymers may be useful as degradable polymers, adhesives, coatings, elastomers, sealants, flexible foams, or structural materials.

The degradation of the polymers may yield the silane polyol, which is used for preparing the polymers. The silane polyol yielded from the degradation of the polymers may be isolated and/or recycled into new materials (e.g., as monomers for preparing polymers, e.g., the polymers described herein).

The provide polymers may be of a cleavage comonomer additive approach. The provide polymers show that a preexisting industrially-relevant thermoset (e.g., polyurethane) formulation may be used as a starting material to react with a small amount of degradable additive to yield thermosets with comparable properties to their nondegradable counterparts. See Shieh et al., Nature, 2020, 583, 542-547. The provided polymers may be advantageous over known polymers at least in part because silyl ether moieties have an unusually high bond strength, can be easily deconstructed with a variety of triggers including fluorides and acids, and/or are good handles for tuning the rate of polymer deconstruction. See Huheey et al., Inorganic Chemistry, 4th ed. (1993); Shieh et al., J. A. Nat. Chem., 2019, 11, 1124-1132. The provided polymers may also be advantageous over known polymers at least in part because the silane polyol is synthetically feasible on a large scale (e.g., available after a single and/or chromatography-free step and/or with a high yield), can be made from cost-effective and readily-available starting materials, and/or is compatible with the reactions for making the polymers (e.g., the polymerization). The silane polyol may be synthesized in one step from convenient starting materials without chromatography. The silane polyol may be integrated into linear and crosslinked polymers (e.g., polyurethanes) without disrupting the thermomechanical properties. The degradation (deconstruction) products of original networks may be recycled into new networks with similar thermomechanical properties to the original networks.

### Definitions

Definitions of specific functional groups and chemical terms are described in more detail below. The chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5^{th} Edition, John Wiley & Sons, Inc., New York, 2001; Larock, Comprehensive Organic Transformations, VCH Publishers, Inc., New York, 1989; and Carruthers, Some Modern Methods of Organic Synthesis, 3^{rd} Edition, Cambridge University Press, Cambridge, 1987.

Compounds described herein can comprise one or more asymmetric centers, and thus can exist in various stereoisomeric forms, e.g., enantiomers and/or diastereomers. For example, the compounds described herein can be in the form of an individual enantiomer, diastereomer or geometric isomer, or can be in the form of a mixture of stereoisomers, including racemic mixtures and mixtures enriched in one or more stereoisomer. Isomers can be isolated from mixtures by methods known to those skilled in the art, including chiral high pressure liquid chromatography (HPLC) and the formation and crystallization of chiral salts; or preferred isomers can be prepared by asymmetric syntheses. See, for example, Jacques et al., Enantiomers, Racemates and Resolutions (Wiley Interscience, New York, 1981); Wilen et al., Tetrahedron 33:2725 (1977); Eliel, E. L. Stereochemistry of Carbon Compounds (McGraw-Hill, NY, 1962); and Wilen, S. H. Tables of Resolving Agents and Optical Resolutions p. 268 (E. L. Eliel, Ed., Univ. of Notre Dame Press, Notre Dame, IN 1972). The invention additionally encompasses compounds as individual isomers substantially free of other isomers, and alternatively, as mixtures of various isomers.

Unless otherwise provided, the description of the moieties and variables recited in a section of the present disclosure applies to the moieties and variables that have the same symbols and are recited in other sections of the present disclosure.

Two or more moieties or variables present at the same time may be the same or different from each other.

When a range of values (“range”) is listed, it is intended to encompass each value and sub-range within the range. A range is inclusive of the values at the two ends of the range unless otherwise provided. For example, “an integer between 1 and 4” refers to 1, 2, 3, and 4. For example “C₁₋₆ alkyl” is intended to encompass, C₁, C₂, C₃, C₄, C₅, C₆, C₁₋₆, C₁₋₅, C₁₋₄, C₁₋₃, C₁₋₂, C₂₋₆, C₂₋₅, C₂₋₄, C₂₋₃, C₃₋₆, C₃₋₅, C₃₋₄, C₄₋₆, C₄₋₅, and C₅₋₆ alkyl.

The term “alkyl” refers to a radical of a C₁-C₁₀₀₀ straight-chain or branched saturated hydrocarbon group. In some embodiments, an alkyl group has 1 to 200 carbon atoms (“C₁-C₂₀₀ alkyl”), 1 to 20 carbon atoms (“C₁-C₂₀ alkyl”), 1 to 10 carbon atoms (“C₁-C₁₀ alkyl”), 1 to 9 carbon atoms (“C₁-C₉ alkyl”), 1 to 8 carbon atoms (“C₁-C₈ alkyl”), 1 to 7 carbon atoms (“C₁-C₇ alkyl”), 1 to 6 carbon atoms (“C₁-C₆ alkyl”), 1 to 5 carbon atoms (“C₁-C₅ alkyl”), 1 to 4 carbon atoms (“C₁-C₄ alkyl”), 1 to 3 carbon atoms (“C₁-C₃ alkyl”), 1 to 2 carbon atoms (“C₁-C₂ alkyl”), or 1 carbon atom (“C₁ alkyl”). In some embodiments, an alkyl group has 2 to 1000 carbon atoms (“C₂₋₁₀₀₀ alkyl”), 2 to 100 carbon atoms (“C₂₋₁₀₀ alkyl”), 2 to 20 carbon atoms (“C₂₋₂₀ alkyl”), 50 to 400 carbon atoms (“C₅₀₋₄₀₀ alkyl”), 2 to 49 carbon atoms (“C₂₋₄₉ alkyl”), or 2 to 12 carbon atoms (“C₂₋₁₂ alkyl”). Examples of C₁-C₆ alkyl groups include methyl (C₁), ethyl (C₂), n-propyl (C₃), isopropyl (C₃), n-butyl (C₄), tert-butyl (C₄), sec-butyl (C₄), iso-butyl (C₄), n-pentyl (C₅), 3-pentanyl (C₅), amyl (C₅), neopentyl (C₅), 3-methyl-2-butanyl (C₅), tertiary amyl (C₅), and n-hexyl (C₆). Additional examples of alkyl groups include n-heptyl (C₇), n-octyl (C₈) and the like. C₃₀-C₁₀₀₀ alkyl may be obtained from polymerization. Unless otherwise specified, each instance of an alkyl group is independently unsubstituted (an “unsubstituted alkyl”) or substituted (a “substituted alkyl”) with one or more substituents.

The term “alkenyl” refers to a radical of a straight-chain or branched hydrocarbon group having from 2 to 1000 carbon atoms and one or more carbon-carbon double bonds (e.g., 1, 2, 3, or 4 double bonds). In some embodiments, an alkenyl group has 2 to 1000 carbon atoms (“C₂₋₁₀₀₀ alkenyl”), 2 to 200 carbon atoms (“C₂₋₂₀₀ alkenyl”), 2 to 100 carbon atoms (“C₂₋₁₀₀ alkenyl”), 2 to 20 carbon atoms (“C₂₋₂₀ alkenyl”), 50 to 400 carbon atoms (“C₅₀₋₄₀₀ alkenyl”), 2 to 49 carbon atoms (“C₂₋₄₉ alkenyl”), or 2 to 12 carbon atoms (“C₂₋₁₂ alkenyl”). In some embodiments, an alkenyl group has 2 to 20 carbon atoms (“C₂₋₂₀ alkenyl”). In some embodiments, an alkenyl group has 2 to 9 carbon atoms (“C₂₋₉ alkenyl”). In some embodiments, an alkenyl group has 2 to 8 carbon atoms (“C₂₋₈ alkenyl”). In some embodiments, an alkenyl group has 2 to 7 carbon atoms (“C₂₋₇ alkenyl”). In some embodiments, an alkenyl group has 2 to 6 carbon atoms (“C₂₋₆ alkenyl”). In some embodiments, an alkenyl group has 2 to 5 carbon atoms (“C₂₋₅ alkenyl”). In some embodiments, an alkenyl group has 2 to 4 carbon atoms (“C₂₋₄ alkenyl”). In some embodiments, an alkenyl group has 2 to 3 carbon atoms (“C₂₋₃ alkenyl”). In some embodiments, an alkenyl group has 2 carbon atoms (“C₂ alkenyl”). The one or more carbon-carbon double bonds can be internal (such as in 2-butenyl) or terminal (such as in 1-butenyl). Examples of C₂₋₄ alkenyl groups include ethenyl (C₂), 1-propenyl (C₃), 2-propenyl (C₃), 1-butenyl (C₄), 2-butenyl (C₄), butadienyl (C₄), and the like. Examples of C₂₋₆ alkenyl groups include the aforementioned C₂₋₄ alkenyl groups as well as pentenyl (C₅), pentadienyl (C₅), hexenyl (C₆), and the like. C₃₀-C₁₀₀₀ alkenyl may be obtained from polymerization. Unless otherwise specified, each instance of an alkenyl group is independently unsubstituted (an “unsubstituted alkenyl”) or substituted (a “substituted alkenyl”) with one or more substituents. In an alkenyl group, a C═C double bond for which the stereochemistry is not specified (e.g., —CH═CHCH₃,

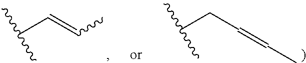

may be in the (E)- or (Z)-configuration.

The term “alkynyl” refers to a radical of a straight-chain or branched hydrocarbon group having from 2 to 1000 carbon atoms and one or more carbon-carbon triple bonds (e.g., 1, 2, 3, or 4 triple bonds). In some embodiments, an alkynyl group has 2 to 1000 carbon atoms (“C₂₋₁₀₀₀ alkynyl”), 2 to 200 carbon atoms (“C₂₋₂₀₀ alkynyl”), 2 to 100 carbon atoms (“C₂₋₁₀₀ alkynyl”), 50 to 400 carbon atoms (“C₅₀₋₄₀₀ alkynyl”), 2 to 49 carbon atoms (“C₂₋₄₉ alkynyl”), 2 to 20 carbon atoms (“C₂₋₂₀ alkynyl”), 2 to 12 carbon atoms (“C₂₋₁₂ alkynyl”), 2 to 9 carbon atoms (“C₂₋₉ alkynyl”), 2 to 8 carbon atoms (“C₂₋₈ alkynyl”), 2 to 7 carbon atoms (“C₂₋₇ alkynyl”), 2 to 6 carbon atoms (“C₂₋₆ alkynyl”), 2 to 5 carbon atoms (“C₂₋₅ alkynyl”), 2 to 4 carbon atoms (“C₂₋₄ alkynyl”), 2 to 3 carbon atoms (“C₂₋₃ alkynyl”), or 2 carbon atoms (“C₂ alkynyl”). The one or more carbon-carbon triple bonds can be internal (such as in 2-butynyl) or terminal (such as in 1-butynyl). Examples of C₂₋₄ alkynyl groups include, without limitation, ethynyl (C₂), 1-propynyl (C₃), 2-propynyl (C₃), 1-butynyl (C₄), 2-butynyl (C₄), and the like. Examples of C₂₋₆ alkenyl groups include the aforementioned C₂₋₄ alkynyl groups as well as pentynyl (C₅), hexynyl (C₆), and the like. C₃₀-C₁₀₀₀ alkynyl may be obtained from polymerization. Unless otherwise specified, each instance of an alkynyl group is independently unsubstituted (an “unsubstituted alkynyl”) or substituted (a “substituted alkynyl”) with one or more substituents.

The term “heteroalkyl” refers to an alkyl group which further includes at least one heteroatom (e.g., 1, 2, 3, 4, or more heteroatoms, as valency permits) selected from oxygen, nitrogen, phosphorus, or sulfur within (i.e., inserted between adjacent carbon atoms of) and/or placed at one or more terminal position(s) of the parent chain. In certain embodiments, a heteroalkyl group refers to a saturated group having from 1 to 1000 carbon atoms and 1 or more heteroatoms within the parent chain (“C₁-C₁₀₀₀ heteroalkyl”), 1 to 20 carbon atoms and 1 or more heteroatoms within the parent chain (“C₁-C₂₀ heteroalkyl”), 1 to 10 carbon atoms and 1 or more heteroatoms within the parent chain (“C₁-C₁₀ heteroalkyl”), 1 to 9 carbon atoms and 1 or more heteroatoms within the parent chain (“C₁-C₉ heteroalkyl”), 1 to 8 carbon atoms and 1 or more heteroatoms within the parent chain (“C₁-C₈ heteroalkyl”), 1 to 7 carbon atoms and 1 or more heteroatoms within the parent chain (“C₁-C₇ heteroalkyl”), 1 to 6 carbon atoms and 1 or more heteroatoms within the parent chain (“C₁-C₆ heteroalkyl”), 1 to 5 carbon atoms and 1 or more heteroatoms within the parent chain (“C₁-C₅ heteroalkyl”), 1 to 4 carbon atoms and 1 or more heteroatoms within the parent chain (“C₁-C₄ heteroalkyl”), 1 to 3 carbon atoms and 1 or more heteroatoms within the parent chain (“C₁-C₃ heteroalkyl”), 1 to 2 carbon atoms and 1 heteroatom within the parent chain (“C₁-C₂ heteroalkyl”), or 1 carbon atom and 1 heteroatom (“C₁ heteroalkyl”). In some embodiments, a heteroalkyl group has 2 to 1000 carbon atoms and 1 or more heteroatoms within the parent chain (“C₂₋₁₀₀₀ heteroalkyl”), 2 to 100 carbon atoms and 1 or more heteroatoms within the parent chain (“C₂₋₁₀₀ heteroalkyl”), 2 to 20 carbon atoms and 1 or more heteroatoms within the parent chain (“C₂₋₂₀ heteroalkyl”), 50 to 400 carbon atoms and 1 or more heteroatoms within the parent chain (“C₅₀₋₄₀₀ heteroalkyl”), 2 to 49 carbon atoms and 1 or more heteroatoms within the parent chain (“C₂₋₄₉ heteroalkyl”), or 2 to 12 carbon atoms and 1 or more heteroatoms within the parent chain (“C₂₋₁₂ heteroalkyl”). C₃₀-C₁₀₀₀ heteroalkyl may be obtained from polymerization. Unless otherwise specified, each instance of a heteroalkyl group is independently unsubstituted (an “unsubstituted heteroalkyl”) or substituted (a “substituted heteroalkyl”) with one or more substituents.

The term “heteroalkenyl” refers to an alkenyl group, which further includes at least one heteroatom (e.g., 1, 2, 3, 4, or more heteroatoms, as valency permits) selected from oxygen, nitrogen, or sulfur within (i.e., inserted between adjacent carbon atoms of) and/or placed at one or more terminal position(s) of the parent chain. In certain embodiments, a heteroalkenyl group refers to a group having from 2 to 20 carbon atoms, at least one double bond, and 1 or more heteroatoms within the parent chain (“heteroC₂₋₂₀ alkenyl”). In certain embodiments, a heteroalkenyl group refers to a group having from 2 to 10 carbon atoms, at least one double bond, and 1 or more heteroatoms within the parent chain (“heteroC₂₋₁₀ alkenyl”). In some embodiments, a heteroalkenyl group has 2 to 9 carbon atoms at least one double bond, and 1 or more heteroatoms within the parent chain (“heteroC₂₋₉ alkenyl”). In some embodiments, a heteroalkenyl group has 2 to 8 carbon atoms, at least one double bond, and 1 or more heteroatoms within the parent chain (“heteroC₂₋₈ alkenyl”). In some embodiments, a heteroalkenyl group has 2 to 7 carbon atoms, at least one double bond, and 1 or more heteroatoms within the parent chain (“heteroC₂₋₇ alkenyl”). In some embodiments, a heteroalkenyl group has 2 to 6 carbon atoms, at least one double bond, and 1 or more heteroatoms within the parent chain (“heteroC₂₋₆ alkenyl”). In some embodiments, a heteroalkenyl group has 2 to 5 carbon atoms, at least one double bond, and 1 or 2 heteroatoms within the parent chain (“heteroC₂₋₅ alkenyl”). In some embodiments, a heteroalkenyl group has 2 to 4 carbon atoms, at least one double bond, and 1 or 2 heteroatoms within the parent chain (“heteroC₂₋₄ alkenyl”). In some embodiments, a heteroalkenyl group has 2 to 3 carbon atoms, at least one double bond, and 1 heteroatom within the parent chain (“heteroC₂₋₃ alkenyl”). In some embodiments, a heteroalkenyl group has 2 to 6 carbon atoms, at least one double bond, and 1 or 2 heteroatoms within the parent chain (“heteroC₂₋₆ alkenyl”). In some embodiments, a heteroalkenyl group has 2 to 1000 carbon atoms and 1 or more heteroatoms within the parent chain (“C₂₋₁₀₀₀ heteroalkenyl”), 2 to 100 carbon atoms and 1 or more heteroatoms within the parent chain (“C₂₋₁₀₀ heteroalkenyl”), 2 to 20 carbon atoms and 1 or more heteroatoms within the parent chain (“C₂₋₂₀ heteroalkenyl”), 50 to 400 carbon atoms and 1 or more heteroatoms within the parent chain (“C₅₀₋₄₀₀ heteroalkenyl”), 2 to 49 carbon atoms and 1 or more heteroatoms within the parent chain (“C₂₋₄₉ heteroalkenyl”), or 2 to 12 carbon atoms and 1 or more heteroatoms within the parent chain (“C₂₋₁₂ heteroalkenyl”). C₃₀-C₁₀₀₀ heteroalkenyl may be obtained from polymerization. Unless otherwise specified, each instance of a heteroalkenyl group is independently unsubstituted (an “unsubstituted heteroalkenyl”) or substituted (a “substituted heteroalkenyl”) with one or more substituents. In certain embodiments, the heteroalkenyl group is an unsubstituted heteroC₂₋₁₀ alkenyl. In certain embodiments, the heteroalkenyl group is a substituted heteroC₂₋₁₀ alkenyl.

The term “heteroalkynyl” refers to an alkynyl group, which further includes at least one heteroatom (e.g., 1, 2, 3, 4, or more heteroatoms, as valency permits) selected from oxygen, nitrogen, or sulfur within (i.e., inserted between adjacent carbon atoms of) and/or placed at one or more terminal position(s) of the parent chain. In certain embodiments, a heteroalkynyl group refers to a group having from 2 to 1000 carbon atoms, at least one triple bond, and 1 or more heteroatoms within the parent chain (“heteroC₂₋₁₀₀₀ alkynyl”). In certain embodiments, a heteroalkynyl group refers to a group having from 2 to 20 carbon atoms, at least one triple bond, and 1 or more heteroatoms within the parent chain (“heteroC₂₋₂₀ alkynyl”). In certain embodiments, a heteroalkynyl group refers to a group having from 2 to 10 carbon atoms, at least one triple bond, and 1 or more heteroatoms within the parent chain (“heteroC₂₋₁₀ alkynyl”). In some embodiments, a heteroalkynyl group has 2 to 9 carbon atoms, at least one triple bond, and 1 or more heteroatoms within the parent chain (“heteroC₂₋₉ alkynyl”). In some embodiments, a heteroalkynyl group has 2 to 8 carbon atoms, at least one triple bond, and 1 or more heteroatoms within the parent chain (“heteroC₂₋₈ alkynyl”). In some embodiments, a heteroalkynyl group has 2 to 7 carbon atoms, at least one triple bond, and 1 or more heteroatoms within the parent chain (“heteroC₂₋₇ alkynyl”). In some embodiments, a heteroalkynyl group has 2 to 6 carbon atoms, at least one triple bond, and 1 or more heteroatoms within the parent chain (“heteroC₂₋₆ alkynyl”). In some embodiments, a heteroalkynyl group has 2 to 5 carbon atoms, at least one triple bond, and 1 or 2 heteroatoms within the parent chain (“heteroC₂₋₅ alkynyl”). In some embodiments, a heteroalkynyl group has 2 to 4 carbon atoms, at least one triple bond, and 1 or 2 heteroatoms within the parent chain (“heteroC₂₋₄ alkynyl”). In some embodiments, a heteroalkynyl group has 2 to 3 carbon atoms, at least one triple bond, and 1 heteroatom within the parent chain (“heteroC₂₋₃ alkynyl”). In some embodiments, a heteroalkynyl group has 2 to 6 carbon atoms, at least one triple bond, and 1 or 2 heteroatoms within the parent chain (“heteroC₂₋₆ alkynyl”). In some embodiments, a heteroalkynyl group has 2 to 1000 carbon atoms and 1 or more heteroatoms within the parent chain (“C₂₋₁₀₀₀ heteroalkynyl”), 2 to 100 carbon atoms and 1 or more heteroatoms within the parent chain (“C₂₋₁₀₀ heteroalkynyl”), 2 to 20 carbon atoms and 1 or more heteroatoms within the parent chain (“C₂₋₂₀ heteroalkynyl”), 50 to 400 carbon atoms and 1 or more heteroatoms within the parent chain (“C₅₀₋₄₀₀ heteroalkynyl”), 2 to 49 carbon atoms and 1 or more heteroatoms within the parent chain (“C₂₋₄₉ heteroalkynyl”), or 2 to 12 carbon atoms and 1 or more heteroatoms within the parent chain (“C₂₋₁₂ heteroalkynyl”). C₃₀-C₁₀₀₀ heteroalkynyl may be obtained from polymerization. Unless otherwise specified, each instance of a heteroalkynyl group is independently unsubstituted (an “unsubstituted heteroalkynyl”) or substituted (a “substituted heteroalkynyl”) with one or more substituents. In certain embodiments, the heteroalkynyl group is an unsubstituted heteroC₂₋₁₀ alkynyl. In certain embodiments, the heteroalkynyl group is a substituted heteroC₂₋₁₀ alkynyl.

The term “carbocyclyl” or “carbocyclic” or “cycloalkyl” refers to a radical of a non-aromatic cyclic hydrocarbon group having from 3 to 10 ring carbon atoms (“C₃₋₁₀ carbocyclyl”) and zero heteroatoms in the non-aromatic ring system. In some embodiments, a carbocyclyl group has 3 to 8 ring carbon atoms (“C₃₋₈ carbocyclyl”), 3 to 7 ring carbon atoms (“C₃₋₇ carbocyclyl”), 3 to 6 ring carbon atoms (“C₃₋₆ carbocyclyl”), 4 to 6 ring carbon atoms (“C₄₋₆ carbocyclyl”), 5 to 6 ring carbon atoms (“C₅₋₆ carbocyclyl”), or 5 to 10 ring carbon atoms (“C₅₋₁₀ carbocyclyl”). Exemplary C₃₋₆ carbocyclyl groups include, without limitation, cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), and the like. Exemplary C₃₋₈ carbocyclyl groups include, without limitation, the aforementioned C₃₋₆ carbocyclyl groups as well as cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), and the like. Exemplary C₃₋₁₀ carbocyclyl groups include, without limitation, the aforementioned C₃₋₈ carbocyclyl groups as well as cyclononyl (C₉), cyclononenyl (C₉), cyclodecyl (C₁₀), cyclodecenyl (C₁₀), octahydro-1H-indenyl (C₉), decahydronaphthalenyl (C₁₀), spiro[4.5]decanyl (C₁₀), and the like. As the foregoing examples illustrate, in certain embodiments, the carbocyclyl group is either monocyclic (“monocyclic carbocyclyl”) or polycyclic (e.g., containing a fused, bridged or spiro ring system such as a bicyclic system (“bicyclic carbocyclyl”) or tricyclic system (“tricyclic carbocyclyl”)) and can be saturated or can contain one or more carbon-carbon double or triple bonds. “Carbocyclyl” also includes ring systems wherein the carbocyclyl ring, as defined above, is fused with one or more aryl or heteroaryl groups wherein the point of attachment is on the carbocyclyl ring, and in such instances, the number of carbons continue to designate the number of carbons in the carbocyclic ring system. Unless otherwise specified, each instance of a carbocyclyl group is independently unsubstituted (an “unsubstituted carbocyclyl”) or substituted (a “substituted carbocyclyl”) with one or more substituents.

The term “heterocyclyl” or “heterocyclic” refers to a radical of a 3- to 14-membered non-aromatic ring system having ring carbon atoms and 1 to 4 ring heteroatoms, wherein each heteroatom is independently selected from nitrogen, oxygen, phosphorus, and sulfur (“3-14 membered heterocyclyl”). In heterocyclyl groups that contain one or more nitrogen atoms, the point of attachment can be a carbon or nitrogen atom, as valency permits. A heterocyclyl group can either be monocyclic (“monocyclic heterocyclyl”) or polycyclic (e.g., a fused, bridged or spiro ring system such as a bicyclic system (“bicyclic heterocyclyl”) or tricyclic system (“tricyclic heterocyclyl”)), and can be saturated or can contain one or more carbon-carbon double or triple bonds. Heterocyclyl polycyclic ring systems can include one or more heteroatoms in one or both rings. “Heterocyclyl” also includes ring systems wherein the heterocyclyl ring, as defined above, is fused with one or more carbocyclyl groups wherein the point of attachment is either on the carbocyclyl or heterocyclyl ring, or ring systems wherein the heterocyclyl ring, as defined above, is fused with one or more aryl or heteroaryl groups, wherein the point of attachment is on the heterocyclyl ring, and in such instances, the number of ring members continue to designate the number of ring members in the heterocyclyl ring system. Unless otherwise specified, each instance of heterocyclyl is independently unsubstituted (an “unsubstituted heterocyclyl”) or substituted (a “substituted heterocyclyl”) with one or more substituents.

In some embodiments, a heterocyclyl group is a 5-10 membered non-aromatic ring system having ring carbon atoms and 1-4 ring heteroatoms, wherein each heteroatom is independently selected from nitrogen, oxygen, phosphorus, and sulfur (“5-10 membered heterocyclyl”). In some embodiments, a heterocyclyl group is a 5-8 membered non-aromatic ring system having ring carbon atoms and 1-4 ring heteroatoms, wherein each heteroatom is independently selected from nitrogen, oxygen, phosphorus, and sulfur (“5-8 membered heterocyclyl”). In some embodiments, a heterocyclyl group is a 5-6 membered non-aromatic ring system having ring carbon atoms and 1-4 ring heteroatoms, wherein each heteroatom is independently selected from nitrogen, oxygen, phosphorus, and sulfur (“5-6 membered heterocyclyl”). In some embodiments, the 5-6 membered heterocyclyl has 1-3 ring heteroatoms selected from nitrogen, oxygen, phosphorus, and sulfur. In some embodiments, the 5-6 membered heterocyclyl has 1-2 ring heteroatoms selected from nitrogen, oxygen, phosphorus, and sulfur. In some embodiments, the 5-6 membered heterocyclyl has 1 ring heteroatom selected from nitrogen, oxygen, phosphorus, and sulfur.

Exemplary 3-membered heterocyclyl groups containing 1 heteroatom include, without limitation, azirdinyl, oxiranyl, and thiiranyl. Exemplary 4-membered heterocyclyl groups containing 1 heteroatom include, without limitation, azetidinyl, oxetanyl and thietanyl. Exemplary 5-membered heterocyclyl groups containing 1 heteroatom include, without limitation, tetrahydrofuranyl, dihydrofuranyl, tetrahydrothiophenyl, dihydrothiophenyl, pyrrolidinyl, dihydropyrrolyl, and pyrrolyl-2,5-dione. Exemplary 5-membered heterocyclyl groups containing 2 heteroatoms include, without limitation, dioxolanyl, oxathiolanyl and dithiolanyl. Exemplary 5-membered heterocyclyl groups containing 3 heteroatoms include, without limitation, triazolinyl, oxadiazolinyl, and thiadiazolinyl. Exemplary 6-membered heterocyclyl groups containing 1 heteroatom include, without limitation, piperidinyl, tetrahydropyranyl, dihydropyridinyl, and thianyl. Exemplary 6-membered heterocyclyl groups containing 2 heteroatoms include, without limitation, piperazinyl, morpholinyl, dithianyl, and dioxanyl. Exemplary 6-membered heterocyclyl groups containing 3 heteroatoms include, without limitation, triazinanyl. Exemplary 7-membered heterocyclyl groups containing 1 heteroatom include, without limitation, azepanyl, oxepanyl, and thiepanyl. Exemplary 8-membered heterocyclyl groups containing 1 heteroatom include, without limitation, azocanyl, oxecanyl and thiocanyl. Exemplary bicyclic heterocyclyl groups include, without limitation, indolinyl, isoindolinyl, dihydrobenzofuranyl, dihydrobenzothienyl, tetrahydrobenzothienyl, tetrahydrobenzofuranyl, tetrahydroindolyl, tetrahydroquinolinyl, tetrahydroisoquinolinyl, decahydroquinolinyl, decahydroisoquinolinyl, octahydrochromenyl, octahydroisochromenyl, decahydronaphthyridinyl, decahydro-1,8-naphthyridinyl, octahydropyrrolo[3,2-b]pyrrole, indolinyl, phthalimidyl, naphthalimidyl, chromanyl, chromenyl, 1H-benzo[e][1,4]diazepinyl, 1,4,5,7-tetrahydropyrano[3,4-b]pyrrolyl, 5,6-dihydro-4H-furo[3,2-b]pyrrolyl, 6,7-dihydro-5H-furo[3,2-b]pyranyl, 5,7-dihydro-4H-thieno[2,3-c]pyranyl, 2,3-dihydro-1H-pyrrolo[2,3-b]pyridinyl, 2,3-dihydrofuro[2,3-b]pyridinyl, 4,5,6,7-tetrahydro-1H-pyrrolo[2,3-b]pyridinyl, 4,5,6,7-tetrahydrofuro[3,2-c]pyridinyl, 4,5,6,7-tetrahydrothieno[3,2-b]pyridinyl, 1,2,3,4-tetrahydro-1,6-naphthyridinyl, and the like.

The term “aryl” refers to a radical of a monocyclic or polycyclic (e.g., bicyclic or tricyclic) 4n+2 aromatic ring system (e.g., having 6, 10, or 14π electrons shared in a cyclic array) having 6-14 ring carbon atoms and zero heteroatoms provided in the aromatic ring system (“C₆₋₁₄ aryl”). In some embodiments, an aryl group has 6 ring carbon atoms (“C₆ aryl”; e.g., phenyl). In some embodiments, an aryl group has 10 ring carbon atoms (“C₁₀ aryl”; e.g., naphthyl such as 1-naphthyl and 2-naphthyl). In some embodiments, an aryl group has 14 ring carbon atoms (“C₁₄ aryl”; e.g., anthracyl). “Aryl” also includes ring systems wherein the aryl ring, as defined above, is fused with one or more carbocyclyl or heterocyclyl groups wherein the radical or point of attachment is on the aryl ring, and in such instances, the number of carbon atoms continue to designate the number of carbon atoms in the aryl ring system. Unless otherwise specified, each instance of an aryl group is independently unsubstituted (an “unsubstituted aryl”) or substituted (a “substituted aryl”) with one or more substituents.

The term “heteroaryl” refers to a radical of a 5-14 membered monocyclic or polycyclic (e.g., bicyclic, tricyclic) 4n+2 aromatic ring system (e.g., having 6, 10, or 14 π electrons shared in a cyclic array) having ring carbon atoms and 1-4 ring heteroatoms provided in the aromatic ring system, wherein each heteroatom is independently selected from nitrogen, oxygen, and sulfur (“5-14 membered heteroaryl”). In heteroaryl groups that contain one or more nitrogen atoms, the point of attachment can be a carbon or nitrogen atom, as valency permits. Heteroaryl polycyclic ring systems can include one or more heteroatoms in one or both rings. “Heteroaryl” includes ring systems wherein the heteroaryl ring, as defined above, is fused with one or more carbocyclyl or heterocyclyl groups wherein the point of attachment is on the heteroaryl ring, and in such instances, the number of ring members continue to designate the number of ring members in the heteroaryl ring system. “Heteroaryl” also includes ring systems wherein the heteroaryl ring, as defined above, is fused with one or more aryl groups wherein the point of attachment is either on the aryl or heteroaryl ring, and in such instances, the number of ring members designates the number of ring members in the fused polycyclic (aryl/heteroaryl) ring system. Polycyclic heteroaryl groups wherein one ring does not contain a heteroatom (e.g., indolyl, quinolinyl, carbazolyl, and the like) the point of attachment can be on either ring, i.e., either the ring bearing a heteroatom (e.g., 2-indolyl) or the ring that does not contain a heteroatom (e.g., 5-indolyl). A heteroaryl group be monovalent or may have more than one point of attachment to another moiety (e.g., it may be divalent, trivalent, etc.), although the valency may be specified directly in the name of the group. For example, “triazoldiyl” refers to a divalent triazolyl moiety.

In some embodiments, a heteroaryl group is a 5-10 membered aromatic ring system having ring carbon atoms and 1-4 ring heteroatoms provided in the aromatic ring system, wherein each heteroatom is independently selected from nitrogen, oxygen, and sulfur (“5-10 membered heteroaryl”). In some embodiments, a heteroaryl group is a 5-8 membered aromatic ring system having ring carbon atoms and 1-4 ring heteroatoms provided in the aromatic ring system, wherein each heteroatom is independently selected from nitrogen, oxygen, and sulfur (“5-8 membered heteroaryl”). In some embodiments, a heteroaryl group is a 5-6 membered aromatic ring system having ring carbon atoms and 1-4 ring heteroatoms provided in the aromatic ring system, wherein each heteroatom is independently selected from nitrogen, oxygen, and sulfur (“5-6 membered heteroaryl”). In some embodiments, the 5-6 membered heteroaryl has 1-3 ring heteroatoms selected from nitrogen, oxygen, and sulfur. In some embodiments, the 5-6 membered heteroaryl has 1-2 ring heteroatoms selected from nitrogen, oxygen, and sulfur. In some embodiments, the 5-6 membered heteroaryl has 1 ring heteroatom selected from nitrogen, oxygen, and sulfur. Unless otherwise specified, each instance of a heteroaryl group is independently unsubstituted (an “unsubstituted heteroaryl”) or substituted (a “substituted heteroaryl”) with one or more substituents.

Exemplary 5-membered heteroaryl groups containing 1 heteroatom include, without limitation, pyrrolyl, furanyl, and thiophenyl. Exemplary 5-membered heteroaryl groups containing 2 heteroatoms include, without limitation, imidazolyl, pyrazolyl, oxazolyl, isoxazolyl, thiazolyl, and isothiazolyl. Exemplary 5-membered heteroaryl groups containing 3 heteroatoms include, without limitation, triazolyl, oxadiazolyl, and thiadiazolyl. Exemplary 5-membered heteroaryl groups containing 4 heteroatoms include, without limitation, tetrazolyl. Exemplary 6-membered heteroaryl groups containing 1 heteroatom include, without limitation, pyridinyl. Exemplary 6-membered heteroaryl groups containing 2 heteroatoms include, without limitation, pyridazinyl, pyrimidinyl, and pyrazinyl. Exemplary 6-membered heteroaryl groups containing 3 or 4 heteroatoms include, without limitation, triazinyl and tetrazinyl, respectively. Exemplary 7-membered heteroaryl groups containing 1 heteroatom include, without limitation, azepinyl, oxepinyl, and thiepinyl. Exemplary 5,6-bicyclic heteroaryl groups include, without limitation, indolyl, isoindolyl, indazolyl, benzotriazolyl, benzothiophenyl, isobenzothiophenyl, benzofuranyl, benzoisofuranyl, benzimidazolyl, benzoxazolyl, benzisoxazolyl, benzoxadiazolyl, benzthiazolyl, benzisothiazolyl, benzthiadiazolyl, indolizinyl, and purinyl. Exemplary 6,6-bicyclic heteroaryl groups include, without limitation, naphthyridinyl, pteridinyl, quinolinyl, isoquinolinyl, cinnolinyl, quinoxalinyl, phthalazinyl, and quinazolinyl. Exemplary tricyclic heteroaryl groups include, without limitation, phenanthridinyl, dibenzofuranyl, carbazolyl, acridinyl, phenothiazinyl, phenoxazinyl and phenazinyl.

As understood from the above, alkyl, alkenyl, alkynyl, carbocyclyl, aryl, and heteroaryl groups are, in certain embodiments, optionally substituted. Optionally substituted refers to a group which may be substituted or unsubstituted (e.g., “substituted” or “unsubstituted” alkyl). In general, the term “substituted” means that at least one hydrogen present on a group is replaced with a permissible substituent, e.g., a substituent which upon substitution results in a stable compound, e.g., a compound which does not spontaneously undergo transformation such as by rearrangement, cyclization, elimination, or other reaction. Unless otherwise indicated, a “substituted” group has a substituent at one or more substitutable positions of the group, and when more than one position in any given structure is substituted, the substituent is either the same or different at each position. The term “substituted” is contemplated to include substitution with all permissible substituents of organic compounds, any of the substituents described herein that results in the formation of a stable compound. The present invention contemplates any and all such combinations in order to arrive at a stable compound. For purposes of this invention, heteroatoms such as nitrogen may have hydrogen substituents and/or any suitable substituent as described herein which satisfy the valencies of the heteroatoms and results in the formation of a stable moiety.

Affixing the suffix “ene” to a group indicates the group is a polyvalent (e.g., bivalent, trivalent, tetravalent, or pentavalent) moiety. In certain embodiments, affixing the suffix “ene” to a group indicates the group is a bivalent moiety.

Exemplary carbon atom substituents include, but are not limited to, halogen, —CN, —NO₂, —N₃, —SO₂H, —SO₃H, —OH, —OR^{aa}, —ON(R^{bb})₂, —N(R^{bb})₂, —N(R^{bb})₃⁺X⁻, —N(OR^{cc})R^{bb}, —SH, —SR^{aa}, —SSR^{cc}, —C(═O)R^{aa}, —CO₂H, —CHO, —C(OR)₂, —CO₂R^{aa}, —OC(═O)R^{aa}, —OCO₂R^{aa}, —C(═O)N(R^{bb})₂, —OC(═O)N(R^{bb})₂, —NR^{bb}C(═O)R^{aa}, —NR^{bb}CO₂R^{aa}, —NR^{bb}C(═O)N(R^{bb})₂, —C(═NR^{bb})R^{aa}, —C(═NR^{bb})OR^{aa}, —OC(═NR^{bb})R^{aa}, —OC(═NR^{bb})OR^{aa}, —C(═NR^{bb})N(R^{bb})₂, —OC(═NR^{bb})N(R^{bb})₂, —NR^{bb}C(═NR^{bb})N(R^{bb})₂, —C(═O)NR^{bb}SO₂R^{aa}, —NR^{bb}SO₂R^{aa}, —SO₂N(R^{bb})₂, —SO₂R^{aa}, —SO₂OR^{aa}, —OSO₂R^{aa}, —S(═O)R^{aa}, —OS(═O)R^{aa}, —Si(R^{aa})₃, —OSi(R^{aa})₃—C(═S)N(R^{bb})₂, —C(═O)SR^{aa}, —C(═S)SR^{aa}, —SC(═S)SR^{aa}, —SC(═O)SR^{aa}, —OC(═O)SR^{aa}, —SC(═O)OR^{aa}, —SC(═O)R^{aa}, —P(═O)(R^{aa})₂, —P(═O)(OR^{cc})₂, —OP(═O)(R^{aa})₂, —OP(═O)(OR^{cc})₂, —P(═O)(N(R^{bb})₂)₂, —OP(═O)(N(R^{bb})₂)₂, —NR^{bb}P(═O)(R^{aa})₂, —NR^{bb}P(═O)(OR^{cc})₂, —NR^{bb}P(═O)(N(R^{bb})₂)₂, —P(R^{cc})₂, —P(OR^{cc})₂, —P(R^{cc})₃⁺X⁻, —P(OR^{cc})₃⁺X⁻, —P(R^{cc})₄, —P(OR^{cc})₄, —OP(R^{cc})₂, —OP(R^{cc})₃⁺X⁻, —OP(OR^{cc})₂, —OP(OR^{cc})₃⁺X⁻, —OP(R^{cc})₄, —OP(OR^{cc})₄, —B(R^{aa})₂, —B(OR^{cc})₂, —BR^{aa}(OR^{cc}), C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups; wherein X⁻ is a counterion;
or two geminal hydrogens on a carbon atom are replaced with the group ═O, ═S, ═NN(R^{bb})₂, ═NNR^{bb}C(═O)R^{aa}, ═NNR^{bb}C(═O)OR^{aa}, —NNR^{bb}S(═O)₂R^{aa}, ═NR^{bb}, or ═NOR^{cc};
each instance of R^{aa} is, independently, selected from C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀alkenyl, heteroC₂₋₁₀alkynyl, C₃₋₁₀ carbocyclyl, 3-14 membered heterocyclyl, C₆₋₁₄ aryl, and 5-14 membered heteroaryl, or two R^{aa} groups are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups;
each instance of R^{bb} is, independently, selected from hydrogen, —OH, —OR^{aa}, —N(R^{cc})₂, —CN, —C(═O)R^{aa}, —C(═O)N(R^{cc})₂, —CO₂R^{aa}, —SO₂R^{aa}, —C(═NR^{cc})OR^{aa}, —C(═NR^{cc})N(R^{cc})₂, —SO₂N(R^{cc})₂, —SO₂R^{cc}, —SO₂OR^{cc}, —SOR^{aa}, —C(═S)N(R^{cc})₂, —C(═O)SR^{cc}, —C(═S)SR^{cc}, —P(═O)(R^{aa})₂, —P(═O)(OR^{cc})₂, —P(═O)(N(R^{cc})₂)₂, C₁₋₁₀ alkyl, C₁₋₁₀ perhaloalkyl, C₂₋₁₀ alkenyl, C₂₋₁₀ alkynyl, heteroC₁₋₁₀alkyl, heteroC₂₋₁₀alkenyl, heteroC₂₋₁₀alkynyl, C₃₋₁₀ carbocyclyl, 3-14 membered heterocyclyl, C₆₋₁₄ aryl, and 5-14 membered heteroaryl, or two R^{bb} groups are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups; wherein X⁻ is a counterion;
each instance of R^{cc} is, independently, selected from hydrogen, C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, or two R^{cc} groups are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups;
each instance of R^{dd} is, independently, selected from halogen, —CN, —NO₂, —N₃, —SO₂H, —SO₃H, —OH, —OR^{ee}, —ON(R^{ff})₂, —N(R^{ff})₂, —N(R^{ff})₃⁺X⁻, —N(OR^{ee})R^{ff}, —SH, —SR^{ee}, —SSR^{ee}, —C(═O)R^{ee}, —CO₂H, —CO₂R^{ee}, —OC(═O)R^{ee}, —OCO₂R^{ee}, —C(═O)N(R^{ff})₂, —OC(═O)N(R^{ff})₂, —NR^{ff}C(═O)R^{ee}, —NR^{ff}CO₂R^{ee}, —NR^{ff}C(═O)N(R^{ff})₂, —C(═NR^{ff})OR^{ee}, —OC(═NR^{ff})R^{ee}, —OC(═NR^{ff})OR^{ee}, —C(═NR^{ff})N(R^{ff})₂, —OC(═NR^{ff})N(R^{ff})₂, —NR^{ff}C(═NR^{ff})N(R^{ff})₂, —NR^{ff}SO₂R^{ee}, —SO₂N(R^{ff})₂, —SO₂R^{ee}, —SO₂OR^{ee}, —OSO₂R^{ee}, —S(═O)R^{ee}, —Si(R^{ee})₃, —OSi(R^{ee})₃, —C(═S)N(R^{ff})₂, —C(═O)SR^{ee}, —C(═S)SR^{ee}, —SC(═S)SR^{ee}, —P(═O)(OR^{ee})₂, —P(═O)(R^{ee})₂, —OP(═O)(R^{ee})₂, —OP(═O)(OR^{ee})₂, C₁₋₆ alkyl, C₁₋₆ perhaloalkyl, C₂₋₆ alkenyl, C₂₋₆ alkynyl, heteroC₁₋₆alkyl, heteroC₂₋₆alkenyl, heteroC₂₋₆alkynyl, C₃₋₁₀ carbocyclyl, 3-10 membered heterocyclyl, C₆₋₁₀ aryl, 5-10 membered heteroaryl, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg} groups, or two geminal R^{dd} substituents can be joined to form ═O or ═S; wherein X⁻ is a counterion;
each instance of R^{ee} is, independently, selected from C₁₋₆ alkyl, C₁₋₆ perhaloalkyl, C₂₋₆ alkenyl, C₂₋₆ alkynyl, heteroC₁₋₆ alkyl, heteroC₂₋₆alkenyl, heteroC₂₋₆ alkynyl, C₃₋₁₀ carbocyclyl, C₆₋₁₀ aryl, 3-10 membered heterocyclyl, and 3-10 membered heteroaryl, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg} groups;
each instance of R^{ff} is, independently, selected from hydrogen, C₁₋₆ alkyl, C₁₋₆ perhaloalkyl, C₂₋₆ alkenyl, C₂₋₆ alkynyl, heteroC₁₋₆alkyl, heteroC₂₋₆alkenyl, heteroC₂₋₆alkynyl, C₃₋₁₀ carbocyclyl, 3-10 membered heterocyclyl, C₆₋₁₀ aryl and 5-10 membered heteroaryl, or two R^{ff} groups are joined to form a 3-10 membered heterocyclyl or 5-10 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg} groups; and
each instance of R^{gg} is, independently, halogen, —CN, —NO₂, —N₃, —SO₂H, —SO₃H, —OH, —OC₁₋₆ alkyl, —ON(C₁₋₆ alkyl)₂, —N(C₁₋₆ alkyl)₂, —N(C₁₋₆ alkyl)₃⁺X⁻, —NH(C₁₋₆ alkyl)₂⁺X⁻, —NH₂(C₁₋₆ alkyl)⁺X⁻, —NH₃⁺X⁻, —N(OC₁₋₆ alkyl)(C₁₋₆ alkyl), —N(OH)(C₁₋₆ alkyl), —NH(OH), —SH, —SC₁₋₆ alkyl, —SS(C₁₋₆ alkyl), —C(═O)(C₁₋₆ alkyl), —CO₂H, —CO₂(C₁₋₆ alkyl), —OC(═O)(C₁₋₆ alkyl), —OCO₂(C₁₋₆ alkyl), —C(═O)NH₂, —C(═O)N(C₁₋₆ alkyl)₂, —OC(═O)NH(C₁₋₆ alkyl), —NHC(═O)(C₁₋₆ alkyl)₂, —N(C₁₋₆ alkyl)C(═O)(C₁₋₆ alkyl), —NHCO₂(C₁₋₆ alkyl), —NHC(═O)N(C₁₋₆ alkyl)₂, —NHC(═O)NH(C₁₋₆ alkyl), —NHC(═O)NH₂, —C(═NH)O(C₁₋₆ alkyl), —OC(═NH)(C₁₋₆ alkyl), —OC(═NH)OC₁₋₆ alkyl, —C(═NH)N(C₁₋₆ alkyl)₂, —C(═NH)NH(C₁₋₆ alkyl), —C(═NH)NH₂, —OC(═NH)N(C₁₋₆ alkyl)₂, —OC(NH)NH(C₁₋₆ alkyl), —OC(NH)NH₂, —NHC(NH)N(C₁₋₆ alkyl)₂, —NHC(═NH)NH₂, —NHSO₂(C₁₋₆ alkyl), —SO₂N(C₁₋₆ alkyl)₂, —SO₂NH(C₁₋₆ alkyl), —SO₂NH₂, —SO₂C₁₋₆ alkyl, —SO₂OC₁₋₆ alkyl, —OSO₂C₁₋₆ alkyl, —SOC₁₋₆ alkyl, —Si(C₁₋₆ alkyl)₃, —OSi(C₁₋₆ alkyl)₃-C(═S)N(C₁₋₆ alkyl)₂, C(═S)NH(C₁₋₆ alkyl), C(═S)NH₂, —C(═O)S(C₁₋₆ alkyl), —C(═S)SC₁₋₆ alkyl, —SC(═S)SC₁₋₆ alkyl, —P(═O)(OC₁₋₆ alkyl)₂, —P(═O)(C₁₋₆ alkyl)₂, —OP(═O)(C₁₋₆ alkyl)₂, —OP(═O)(OC₁₋₆ alkyl)₂, C₁₋₆ alkyl, C₁₋₆ perhaloalkyl, C₂₋₆ alkenyl, C₂₋₆ alkynyl, heteroC₁₋₆alkyl, heteroC₂₋₆alkenyl, heteroC₂₋₆alkynyl, C₃₋₁₀ carbocyclyl, C₆₋₁₀ aryl, 3-10 membered heterocyclyl, 5-10 membered heteroaryl; or two geminal R^{gg} substituents can be joined to form ═O or ═S; wherein X⁻ is a counterion.

In certain embodiments, the carbon atom substituents are independently halogen, substituted or unsubstituted, C₁₋₆ alkyl, —OR^{aa}, —SR^{aa}, —N(R^{bb})₂, —CN, —SCN, —NO₂, —C(═O)R^{aa}, —CO₂R^{aa}, —C(═O)N(R^{bb})₂, —OC(═O)R^{aa}, —OCO₂R^{aa}, —OC(═O)N(R^{bb})₂, —NR^{bb}C(═O)R^{aa}, —NR^{bb}CO₂R^{aa}, or —NR^{bb}C(═O)N(R^{bb})₂. In certain embodiments, the carbon atom substituents are independently halogen, substituted or unsubstituted, C₁₋₆ alkyl, —OR^{aa}, —SR^{aa}, —N(R^{bb})₂, —CN, —SCN, or —NO₂.

Nitrogen atoms can be substituted or unsubstituted as valency permits, and include primary, secondary, tertiary, and quaternary nitrogen atoms. Exemplary nitrogen atom substituents include, but are not limited to, hydrogen, —OH, —OR^{aa}, —N(R^{cc})₂, —CN, —C(═O)R^{aa}, —C(═O)N(R^{cc})₂, —CO₂R^{aa}, —SO₂R^{aa}, —C(═NR^{bb})R^{aa}, —C(═NR^{cc})OR^{aa}, —C(═NR^{cc})N(R^{cc})₂, —SO₂N(R^{cc})₂, —SO₂R^{cc}, —SO₂OR^{cc}, —SOR^{aa}, —C(═S)N(R^{cc})₂, —C(═O)SR^{cc}, —C(═S)SR^{cc}, —P(═O)(OR^{cc})₂, —P(═O)(R^{aa})₂, —P(═O)(N(R^{cc})₂)₂, C₁₋₁₀ alkyl, C₁₋₁₀ perhaloalkyl, C₂₋₁₀ alkenyl, C₂₋₁₀ alkynyl, heteroC₁₋₁₀alkyl, heteroC₂₋₁₀alkenyl, heteroC₂₋₁₀alkynyl, C₃₋₁₀ carbocyclyl, 3-14 membered heterocyclyl, C₆₋₁₄ aryl, and 5-14 membered heteroaryl, or two R^{cc} groups attached to an N atom are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups, and wherein R^{aa}, R^{bb}, R^{cc} and R^{dd} are as defined above.

In certain embodiments, the substituent present on the nitrogen atom is an nitrogen protecting group (also referred to herein as an “amino protecting group”). Nitrogen protecting groups include, but are not limited to, —OH, —OR^{aa}, —N(R^{cc})₂, —C(═O)R^{aa}, —C(═O)N(R^{cc})₂, —CO₂R^{aa}, —SO₂R^{aa}, —C(═NR^{cc})R^{aa}, —C(═NR^{cc})OR^{aa}, —C(═NR^{cc})N(R^{cc})₂, —SO₂N(R^{cc})₂, —SO₂R^{cc}, —SO₂OR^{cc}, —SOR^{aa}, —C(═S)N(R^{cc})₂, —C(═O)SR^{cc}, —C(═S)SR^{cc}, C₁₋₁₀ alkyl (e.g., aralkyl, heteroaralkyl), C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl groups, wherein each alkyl, alkenyl, alkynyl, heteroalkyl, heteroalkenyl, heteroalkynyl, carbocyclyl, heterocyclyl, aralkyl, aryl, and heteroaryl is independently substituted with 0, 1, 2, 3, 4, or 5 R^{dd} groups, and wherein R^{aa}, R^{bb}, R^{cc} and R^{dd} are as defined herein. Nitrogen protecting groups are well known in the art and include those described in detail in Protecting Groups in Organic Synthesis, T. W. Greene and P. G. M. Wuts, 3^{rd} edition, John Wiley & Sons, 1999, incorporated herein by reference.

For example, nitrogen protecting groups such as amide groups (e.g., —C(═O)R^{aa}) include, but are not limited to, formamide, acetamide, chloroacetamide, trichloroacetamide, trifluoroacetamide, phenylacetamide, 3-phenylpropanamide, picolinamide, 3-pyridylcarboxamide, N-benzoylphenylalanyl derivative, benzamide, p-phenylbenzamide, o-nitophenylacetamide, o-nitrophenoxyacetamide, acetoacetamide, (N′-dithiobenzyloxyacylamino) acetamide, 3-(p-hydroxyphenyl) propanamide, 3-(o-nitrophenyl) propanamide, 2-methyl-2-(o-nitrophenoxy) propanamide, 2-methyl-2-(o-phenylazophenoxy) propanamide, 4-chlorobutanamide, 3-methyl-3-nitrobutanamide, o-nitrocinnamide, N-acetylmethionine derivative, o-nitrobenzamide and o-(benzoyloxymethyl)benzamide.

Nitrogen protecting groups such as carbamate groups (e.g., —C(═O)OR^{aa}) include, but are not limited to, methyl carbamate, ethyl carbamate, 9-fluorenylmethyl carbamate (Fmoc), 9-(2-sulfo) fluorenylmethyl carbamate, 9-(2,7-dibromo) fluoroenylmethyl carbamate, 2,7-di-t-butyl-[9-(10,10-dioxo-10,10,10,10-tetrahydrothioxanthyl)] methyl carbamate (DBD-Tmoc), 4-methoxyphenacyl carbamate (Phenoc), 2,2,2-trichloroethyl carbamate (Troc), 2-trimethylsilylethyl carbamate (Teoc), 2-phenylethyl carbamate (hZ), 1-(1-adamantyl)-1-methylethyl carbamate (Adpoc), 1,1-dimethyl-2-haloethyl carbamate, 1,1-dimethyl-2,2-dibromoethyl carbamate (DB-t-BOC), 1,1-dimethyl-2,2,2-trichloroethyl carbamate (TCBOC), 1-methyl-1-(4-biphenylyl)ethyl carbamate (Bpoc), 1-(3,5-di-t-butylphenyl)-1-methylethyl carbamate (t-Bumeoc), 2-(2′- and 4′-pyridyl)ethyl carbamate (Pyoc), 2-(N,N-dicyclohexylcarboxamido)ethyl carbamate, t-butyl carbamate (BOC or Boc), 1-adamantyl carbamate (Adoc), vinyl carbamate (Voc), allyl carbamate (Alloc), 1-isopropylallyl carbamate (Ipaoc), cinnamyl carbamate (Coc), 4-nitrocinnamyl carbamate (Noc), 8-quinolyl carbamate, N-hydroxypiperidinyl carbamate, alkyldithio carbamate, benzyl carbamate (Cbz), p-methoxybenzyl carbamate (Moz), p-nitobenzyl carbamate, p-bromobenzyl carbamate, p-chlorobenzyl carbamate, 2,4-dichlorobenzyl carbamate, 4-methylsulfinylbenzyl carbamate (Msz), 9-anthrylmethyl carbamate, diphenylmethyl carbamate, 2-methylthioethyl carbamate, 2-methylsulfonylethyl carbamate, 2-(p-toluenesulfonyl)ethyl carbamate, [2-(1,3-dithianyl)]methyl carbamate (Dmoc), 4-methylthiophenyl carbamate (Mtpc), 2,4-dimethylthiophenyl carbamate (Bmpc), 2-phosphonioethyl carbamate (Peoc), 2-triphenylphosphonioisopropyl carbamate (Ppoc), 1,1-dimethyl-2-cyanoethyl carbamate, m-chloro-p-acyloxybenzyl carbamate, p-(dihydroxyboryl)benzyl carbamate, 5-benzisoxazolylmethyl carbamate, 2-(trifluoromethyl)-6-chromonylmethyl carbamate (Tcroc), m-nitrophenyl carbamate, 3,5-dimethoxybenzyl carbamate, o-nitrobenzyl carbamate, 3,4-dimethoxy-6-nitrobenzyl carbamate, phenyl(o-nitrophenyl)methyl carbamate, t-amyl carbamate, S-benzyl thiocarbamate, p-cyanobenzyl carbamate, cyclobutyl carbamate, cyclohexyl carbamate, cyclopentyl carbamate, cyclopropylmethyl carbamate, p-decyloxybenzyl carbamate, 2,2-dimethoxyacylvinyl carbamate, o-(N,N-dimethylcarboxamido) benzyl carbamate, 1,1-dimethyl-3-(N,N-dimethylcarboxamido) propyl carbamate, 1,1-dimethylpropynyl carbamate, di(2-pyridyl) methyl carbamate, 2-furanylmethyl carbamate, 2-iodoethyl carbamate, isoborynl carbamate, isobutyl carbamate, isonicotinyl carbamate, p-(p′-methoxyphenylazo)benzyl carbamate, 1-methylcyclobutyl carbamate, 1-methylcyclohexyl carbamate, 1-methyl-1-cyclopropylmethyl carbamate, 1-methyl-1-(3,5-dimethoxyphenyl)ethyl carbamate, 1-methyl-1-(p-phenylazophenyl)ethyl carbamate, 1-methyl-1-phenylethyl carbamate, 1-methyl-1-(4-pyridyl)ethyl carbamate, phenyl carbamate, p-(phenylazo)benzyl carbamate, 2,4,6-tri-t-butylphenyl carbamate, 4-(trimethylammonium) benzyl carbamate, and 2,4,6-trimethylbenzyl carbamate.

Nitrogen protecting groups such as sulfonamide groups (e.g., —S(═O)₂R^{aa}) include, but are not limited to, p-toluenesulfonamide (Ts), benzenesulfonamide, 2,3,6-trimethyl-4-methoxybenzenesulfonamide (Mtr), 2,4,6-trimethoxybenzenesulfonamide (Mtb), 2,6-dimethyl-4-methoxybenzenesulfonamide (Pme), 2,3,5,6-tetramethyl-4-methoxybenzenesulfonamide (Mte), 4-methoxybenzenesulfonamide (Mbs), 2,4,6-trimethylbenzenesulfonamide (Mts), 2,6-dimethoxy-4-methylbenzenesulfonamide (iMds), 2,2,5,7,8-pentamethylchroman-6-sulfonamide (Pmc), methanesulfonamide (Ms), β-trimethylsilylethanesulfonamide (SES), 9-anthracenesulfonamide, 4-(4′,8′-dimethoxynaphthylmethyl)benzenesulfonamide (DNMBS), benzylsulfonamide, trifluoromethylsulfonamide, and phenacylsulfonamide.

Other nitrogen protecting groups include, but are not limited to, phenothiazinyl-(10)-acyl derivative, N′-p-toluenesulfonylaminoacyl derivative, N′-phenylaminothioacyl derivative, N-benzoylphenylalanyl derivative, N-acetylmethionine derivative, 4,5-diphenyl-3-oxazolin-2-one, N-phthalimide, N-dithiasuccinimide (Dts), N-2,3-diphenylmaleimide, N-2,5-dimethylpyrrole, N-1,1,4,4-tetramethyldisilylazacyclopentane adduct (STABASE), 5-substituted 1,3-dimethyl-1,3,5-triazacyclohexan-2-one, 5-substituted 1,3-dibenzyl-1,3,5-triazacyclohexan-2-one, 1-substituted 3,5-dinitro-4-pyridone, N-methylamine, N-allylamine, N-[2-(trimethylsilyl)ethoxy]methylamine (SEM), N-3-acetoxypropylamine, N-(1-isopropyl-4-nitro-2-oxo-3-pyroolin-3-yl) amine, quaternary ammonium salts, N-benzylamine, N-di(4-methoxyphenyl)methylamine, N-5-dibenzosuberylamine, N-triphenylmethylamine (Tr), N-[(4-methoxyphenyl)diphenylmethyl]amine (MMTr), N-9-phenylfluorenylamine (PhF), N-2,7-dichloro-9-fluorenylmethyleneamine, N-ferrocenylmethylamino (Fcm), N-2-picolylamino N′-oxide, N-1,1-dimethylthiomethyleneamine, N-benzylideneamine, N-p-methoxybenzylideneamine, N-diphenylmethyleneamine, N-[(2-pyridyl) mesityl]methyleneamine, N—(N′,N′-dimethylaminomethylene) amine, N,N′-isopropylidenediamine, N-p-nitrobenzylideneamine, N-salicylideneamine, N-5-chlorosalicylideneamine, N-(5-chloro-2-hydroxyphenyl)phenylmethyleneamine, N-cyclohexylideneamine, N-(5,5-dimethyl-3-oxo-1-cyclohexenyl)amine, N-borane derivative, N-diphenylborinic acid derivative, N-[phenyl(pentaacylchromium- or tungsten) acyl]amine, N-copper chelate, N-zinc chelate, N-nitroamine, N-nitrosoamine, amine N-oxide, diphenylphosphinamide (Dpp), dimethylthiophosphinamide (Mpt), diphenylthiophosphinamide (Ppt), dialkyl phosphoramidates, dibenzyl phosphoramidate, diphenyl phosphoramidate, benzenesulfenamide, o-nitrobenzenesulfenamide (Nps), 2,4-dinitrobenzenesulfenamide, pentachlorobenzenesulfenamide, 2-nitro-4-methoxybenzenesulfenamide, triphenylmethylsulfenamide, and 3-nitropyridinesulfenamide (Npys).

In certain embodiments, the substituent present on an oxygen atom is an oxygen protecting group (also referred to herein as an “hydroxyl protecting group”). Oxygen protecting groups include, but are not limited to, —R^{aa}, —N(R^{bb})₂, —C(═O)SR^{aa}, —C(═O)R^{aa}, —CO₂R^{aa}, —C(═O)N(R^{bb})₂, —C(═NR^{bb})R^{aa}, —C(═NR^{bb})OR^{aa}, —C(═NR^{bb})N(R^{bb})₂, —S(═O)R^{aa}, —SO₂R^{aa}, —Si(R^{aa})₃, —P(R^{cc})₂, —P(R^{cc})₃⁺X⁻, —P(OR^{cc})₂, —P(OR^{cc})₃⁺X⁻, —P(═O)(R^{aa})₂, —P(═O)(OR^{cc})₂, and —P(═O)(N(R^{bb})₂)₂, wherein X⁻, R^{aa}, R^{bb}, and R^{cc} are as defined herein. Oxygen protecting groups are well known in the art and include those described in detail in Protecting Groups in Organic Synthesis, T. W. Greene and P. G. M. Wuts, 3^{rd} edition, John Wiley & Sons, 1999, incorporated herein by reference.

Exemplary oxygen protecting groups include, but are not limited to, methyl, methoxylmethyl (MOM), methylthiomethyl (MTM), t-butylthiomethyl, (phenyldimethylsilyl) methoxymethyl (SMOM), benzyloxymethyl (BOM), p-methoxybenzyloxymethyl (PMBM), (4-methoxyphenoxy) methyl (p-AOM), guaiacolmethyl (GUM), t-butoxymethyl, 4-pentenyloxymethyl (POM), siloxymethyl, 2-methoxyethoxymethyl (MEM), 2,2,2-trichloroethoxymethyl, bis(2-chloroethoxy)methyl, 2-(trimethylsilyl)ethoxymethyl (SEMOR), tetrahydropyranyl (THP), 3-bromotetrahydropyranyl, tetrahydrothiopyranyl, 1-methoxycyclohexyl, 4-methoxytetrahydropyranyl (MTHP), 4-methoxytetrahydrothiopyranyl, 4-methoxytetrahydrothiopyranyl S,S-dioxide, 1-[(2-chloro-4-methyl)phenyl]-4-methoxypiperidin-4-yl (CTMP), 1,4-dioxan-2-yl, tetrahydrofuranyl, tetrahydrothiofuranyl, 2,3,3a,4,5,6,7,7a-octahydro-7,8,8-trimethyl-4,7-methanobenzofuran-2-yl, 1-ethoxyethyl, 1-(2-chloroethoxy)ethyl, 1-methyl-1-methoxyethyl, 1-methyl-1-benzyloxyethyl, 1-methyl-1-benzyloxy-2-fluoroethyl, 2,2,2-trichloroethyl, 2-trimethylsilylethyl, 2-(phenylselenyl)ethyl, t-butyl, allyl, p-chlorophenyl, p-methoxyphenyl, 2,4-dinitrophenyl, benzyl (Bn), p-methoxybenzyl, 3,4-dimethoxybenzyl, o-nitrobenzyl, p-nitrobenzyl, p-halobenzyl, 2,6-dichlorobenzyl, p-cyanobenzyl, p-phenylbenzyl, 2-picolyl, 4-picolyl, 3-methyl-2-picolyl N-oxido, diphenylmethyl, p,p′-dinitrobenzhydryl, 5-dibenzosuberyl, triphenylmethyl, α-naphthyldiphenylmethyl, p-methoxyphenyldiphenylmethyl, di(p-methoxyphenyl)phenylmethyl, tri(p-methoxyphenyl)methyl, 4-(4′-bromophenacyloxyphenyl)diphenylmethyl, 4,4′,4″-tris(4,5-dichlorophthalimidophenyl)methyl, 4,4′,4″-tris(levulinoyloxyphenyl)methyl, 4,4′,4″-tris(benzoyloxyphenyl)methyl, 3-(imidazol-1-yl)bis(4′,4″-dimethoxyphenyl)methyl, 1,1-bis(4-methoxyphenyl)-1′-pyrenylmethyl, 9-anthryl, 9-(9-phenyl)xanthenyl, 9-(9-phenyl-10-oxo)anthryl, 1,3-benzodithiolan-2-yl, benzisothiazolyl S,S-dioxido, trimethylsilyl (TMS), triethylsilyl (TES), triisopropylsilyl (TIPS), dimethylisopropylsilyl (IPDMS), diethylisopropylsilyl (DEIPS), dimethylthexylsilyl, t-butyldimethylsilyl (TBDMS), t-butyldiphenylsilyl (TBDPS), tribenzylsilyl, tri-p-xylylsilyl, triphenylsilyl, diphenylmethylsilyl (DPMS), t-butylmethoxyphenylsilyl (TBMPS), formate, benzoylformate, acetate, chloroacetate, dichloroacetate, trichloroacetate, trifluoroacetate, methoxyacetate, triphenylmethoxyacetate, phenoxyacetate, p-chlorophenoxyacetate, 3-phenylpropionate, 4-oxopentanoate (levulinate), 4,4-(ethylenedithio) pentanoate (levulinoyldithioacetal), pivaloate, adamantoate, crotonate, 4-methoxycrotonate, benzoate, p-phenylbenzoate, 2,4,6-trimethylbenzoate (mesitoate), methyl carbonate, 9-fluorenylmethyl carbonate (Fmoc), ethyl carbonate, 2,2,2-trichloroethyl carbonate (Troc), 2-(trimethylsilyl)ethyl carbonate (TMSEC), 2-(phenylsulfonyl)ethyl carbonate (Psec), 2-(triphenylphosphonio) ethyl carbonate (Peoc), isobutyl carbonate, vinyl carbonate, allyl carbonate, t-butyl carbonate (BOC or Boc), p-nitrophenyl carbonate, benzyl carbonate, p-methoxybenzyl carbonate, 3,4-dimethoxybenzyl carbonate, o-nitrobenzyl carbonate, p-nitrobenzyl carbonate, S-benzyl thiocarbonate, 4-ethoxy-1-napththyl carbonate, methyl dithiocarbonate, 2-iodobenzoate, 4-azidobutyrate, 4-nitro-4-methylpentanoate, o-(dibromomethyl)benzoate, 2-formylbenzenesulfonate, 2-(methylthiomethoxy)ethyl, 4-(methylthiomethoxy) butyrate, 2-(methylthiomethoxymethyl)benzoate, 2,6-dichloro-4-methylphenoxyacetate, 2,6-dichloro-4-(1,1,3,3-tetramethylbutyl) phenoxyacetate, 2,4-bis(1,1-dimethylpropyl) phenoxyacetate, chlorodiphenylacetate, isobutyrate, monosuccinoate, (E)-2-methyl-2-butenoate, o-(methoxyacyl)benzoate, a-naphthoate, nitrate, alkyl N,N,N′,N′-tetramethylphosphorodiamidate, alkyl N-phenylcarbamate, borate, dimethylphosphinothioyl, alkyl 2,4-dinitrophenylsulfenate, sulfate, methanesulfonate (mesylate), benzylsulfonate, and tosylate (Ts).

In certain embodiments, the substituent present on a sulfur atom is a sulfur protecting group (also referred to as a “thiol protecting group”). Sulfur protecting groups include, but are not limited to, —R^{aa}, —N(R^{bb})₂, —C(═O)SR^{aa}, —C(═O)R^{aa}, —CO₂R^{aa}, —C(═O)N(R^{bb})₂, —C(═NR^{bb})R^{aa}, —C(═NR^{bb})OR^{aa}, —C(═NR^{bb})N(R^{bb})₂, —S(═O)R^{aa}, —SO₂R^{aa}, —Si(R^{aa})₃, —P(R^{cc})₂, —P(R^{cc})₃⁺X⁻, —P(OR^{cc})₂, —P(OR^{cc})₃⁺X⁻, —P(═O)(R^{aa})₂, —P(═O)(OR^{cc})₂, and —P(═O)(N(R^{bb})₂)₂, wherein R^{aa}, R^{bb}, and R^{cc} are as defined herein. Sulfur protecting groups are well known in the art and include those described in detail in Protecting Groups in Organic Synthesis, T. W. Greene and P. G. M. Wuts, 3^{rd} edition, John Wiley & Sons, 1999, incorporated herein by reference.

The term “halo” or “halogen” refers to fluorine (fluoro, —F), chlorine (chloro, —Cl), bromine (bromo, —Br), or iodine (iodo, —I).

The term “hydroxyl” or “hydroxy” refers to the group —OH.

The term “thiol” or “thio” refers to the group —SH.

The term “amine” or “amino” refers to the group —NH— or —NH₂.

A “counterion” or “anionic counterion” is a negatively charged group associated with a positively charged group in order to maintain electronic neutrality. An anionic counterion may be monovalent (i.e., including one formal negative charge). An anionic counterion may also be multivalent (i.e., including more than one formal negative charge), such as divalent or trivalent. Exemplary counterions include halide ions (e.g., F⁻, Cl⁻, Br⁻, I⁻), NO₃⁻, ClO₄⁻, OH⁻, H₂PO₄⁻, HCO₃⁻, HSO₄⁻, sulfonate ions (e.g., methansulfonate, trifluoromethanesulfonate (triflate), p-toluenesulfonate, benzenesulfonate, 10-camphor sulfonate, naphthalene-2-sulfonate, naphthalene-1-sulfonic acid-5-sulfonate, ethan-1-sulfonic acid-2-sulfonate, and the like), carboxylate ions (e.g., acetate, propanoate, benzoate, glycerate, lactate, tartrate, glycolate, gluconate, and the like), BF₄⁻, PF₄⁻, PF₆⁻, AsF₆⁻, SbF₆⁻, B[3,5-(CF₃)₂C₆H₃]₄]⁻, B(C₆F₅)₄⁻, BPh₄⁻, Al(OC(CF₃)₃)₄⁻, and carborane anions (e.g., CB₁₁H₁₂⁻ or (HCB₁₁Me₅Br₆)⁻). Exemplary counterions which may be multivalent include CO₃²⁻, HPO₄²⁻, PO₄³⁻, B₄O₇²⁻, SO₄²⁻, S₂O₃²⁻, carboxylate anions (e.g., tartrate, citrate, fumarate, maleate, malate, malonate, gluconate, succinate, glutarate, adipate, pimelate, suberate, azelate, sebacate, salicylate, phthalates, aspartate, glutamate, and the like), and carboranes. In certain embodiments, the counterion is triflate.

The term “salt” refers to ionic compounds that result from the neutralization reaction of an acid and a base. A salt is composed of one or more cations (positively charged ions) and one or more anions (negative ions) so that the salt is electrically neutral (without a net charge). Salts of the compounds of this invention include those derived from inorganic and organic acids and bases. Examples of acid addition salts are salts of an amino group formed with inorganic acids such as hydrochloric acid, hydrobromic acid, phosphoric acid, sulfuric acid, and perchloric acid, or with organic acids such as acetic acid, oxalic acid, maleic acid, tartaric acid, citric acid, succinic acid, or malonic acid or by using other methods known in the art such as ion exchange. Other salts include adipate, alginate, ascorbate, aspartate, benzenesulfonate, benzoate, bisulfate, borate, butyrate, camphorate, camphorsulfonate, citrate, cyclopentanepropionate, digluconate, dodecylsulfate, ethanesulfonate, formate, fumarate, glucoheptonate, glycerophosphate, gluconate, hemisulfate, heptanoate, hexanoate, hydroiodide, 2-hydroxy-ethanesulfonate, lactobionate, lactate, laurate, lauryl sulfate, malate, maleate, malonate, methanesulfonate, 2-naphthalenesulfonate, nicotinate, nitrate, oleate, oxalate, palmitate, pamoate, pectinate, persulfate, 3-phenylpropionate, phosphate, picrate, pivalate, propionate, stearate, succinate, sulfate, tartrate, thiocyanate, p-toluenesulfonate, undecanoate, valerate salts, and the like. Salts derived from appropriate bases include alkali metal, alkaline earth metal, ammonium and N⁺(C₁₋₄ alkyl)₄ salts. Representative alkali or alkaline earth metal salts include sodium, lithium, potassium, calcium, magnesium, and the like. Further salts include ammonium, quaternary ammonium, and amine cations formed using counterions such as halide, hydroxide, carboxylate, sulfate, phosphate, nitrate, lower alkyl sulfonate, and aryl sulfonate.

The term “solvate” refers to forms of the compound, or a salt thereof, that are associated with a solvent, usually by a solvolysis reaction. This physical association may include hydrogen bonding. Conventional solvents include water, methanol, ethanol, acetic acid, DMSO, THF, diethyl ether, and the like. The compounds described herein may be prepared, e.g., in crystalline form, and may be solvated. Suitable solvates include pharmaceutically acceptable solvates and further include both stoichiometric solvates and non-stoichiometric solvates. In certain instances, the solvate will be capable of isolation, for example, when one or more solvent molecules are incorporated in the crystal lattice of a crystalline solid. “Solvate” encompasses both solution-phase and isolatable solvates. Representative solvates include hydrates, ethanolates, and methanolates.

The term “hydrate” refers to a compound that is associated with water. Typically, the number of the water molecules contained in a hydrate of a compound is in a definite ratio to the number of the compound molecules in the hydrate. Therefore, a hydrate of a compound may be represented, for example, by the general formula R·x H₂O, wherein R is the compound, and x is a number greater than 0. A given compound may form more than one type of hydrate, including, e.g., monohydrates (x is 1), lower hydrates (x is a number greater than 0 and smaller than 1, e.g., hemihydrates (R·0.5 H₂O)), and polyhydrates (x is a number greater than 1, e.g., dihydrates (R·2 H₂O) and hexahydrates (R·6 H₂O)).

Compositions described herein can be prepared by any method known in the art. In general, such preparatory methods include bringing the polymer into association with an excipient, and/or one or more other accessory ingredients, and then, if necessary and/or desirable, shaping, and/or packaging the product into a desired unit.

Kits may be commercial packs or reagent packs. The kits may further comprise a container (e.g., a vial, ampule, bottle, syringe, and/or dispenser package, or other suitable container). In certain embodiments, a kit further comprises instructions for using the compound. In certain embodiments, a kit further comprises instructions for using the polymer.

Use of the phrase “at least one instance” refers to 1, 2, 3, 4, or more instances, but also encompasses a range, e.g., for example, from 1 to 4, from 1 to 3, from 1 to 2, from 2 to 4, from 2 to 3, or from 3 to 4 instances, inclusive

The term “oligomer” refers to a compound comprising two to ten, inclusive, directly or indirectly covalently connected repeating units. In certain embodiments, an oligomer comprises two to five, inclusive, directly or indirectly covalently connected repeating units. In certain embodiments, an oligomer comprises six to ten, inclusive, directly or indirectly covalently connected repeating units.

The term “polymer” refers to a compound comprising eleven or more, directly or indirectly covalently connected repeating units. In certain embodiments, a polymer is naturally occurring. In certain embodiments, a polymer is synthetic (e.g., not naturally occurring). In certain embodiments, the number-average molecular weight (e.g., as determined by gel permeation chromatography) of a polymer is between 1,000 and 2,000, between 2,000 and 10,000, between 10,000 and 30,000, between 30,000 and 100,000, between 100,000 and 300,000, between 300,000 and 1,000,000, g/mol, inclusive.

When a polymer is prepared by polymerizing two or more different types of monomers, the monomers may be referred to as comonomers. The polymer may be referred to as a copolymer.

The term “average molecular weight” may encompass the number average molecular weight (Mₙ), weight average molecular weight (M_{w}), higher average molecular weight (M_{z} or M_{z}+1), GPC/SEC (gel permeation chromatography/size-exclusion chromatography)-determined average molecular weight (Mₚ), and viscosity average molecular weight (Mᵥ). Average molecular weight may also refer to average molecular weight as determined by gel permeation chromatography.

The term “degree of polymerization” (DP) refers to the number of repeating units in a polymer. In certain embodiments, the DP is determined by a chromatographic method, such as gel permeation chromatography. For a homopolymer, the DP refers to the number of repeating units included in the homopolymer. For a copolymer of two types of monomers (e.g., a first monomer and a second monomer) wherein the molar ratio of the two types of monomers is about 1:1, the DP refers to the number of repeating units of either one of the two type of monomers included in the copolymer. For a copolymer of two types of monomers (e.g., a first monomer and a second monomer) wherein the molar ratio of the two types of monomers is not about 1:1, two DPs may be used. A first DP refers to the number of repeating units of the first monomer included in the copolymer, and a second DP refers to the number of repeating units of the second monomer included in the copolymer. Unless provided otherwise, a DP of “xx”, wherein xx is an integer, refers to the number of repeating units of either one of the two types of monomers of a copolymer of two types of monomers (e.g., a first monomer and a second monomer) wherein the molar ratio of the two types of monomers is about 1:1. Unless provided otherwise, a DP of “xx-yy”, wherein xx and yy are integers, refers to xx being the number of repeating units of the first monomer, and yy being the number of repeating units of the second monomer, of a copolymer of two types of monomers (e.g., a first monomer and a second monomer) wherein the molar ratio of the two types of monomers is not about 1:1.

The term “equivalent ratio” of a first compound to a second compound refers to the combined molar ratio of the C—OH, —NH₂, —NH—, ═N—OH, and —NCO of the first compound to the C—OH, —NH₂, —NH—, ═N—OH, and —NCO of the second compound. For example, the equivalent ratio of glycerol to hexamethylene diisocyanate at the molar ratio of 1:1 is 3:2 because 1 mole of glycerol includes 3 moles of —OH, and 1 mole of hexamethylene diisocyanate includes 2 moles of —NCO.

The term “substantially free” refers to between 90% and 95%, between 95% and 97%, between 97% and 99%, between 99% and 99.5%, or between 99.5% and 99.9%, free.

The disclosure is not intended to be limited in any manner by the above exemplary listing of substituents. Additional terms may be defined in other sections of this disclosure.

Any two instances of a first monomer (e.g., silane polyol) are the same as or different from each other, any two instances of a second monomer (e.g., polyisocyanate) are the same as or different from each other, any two instances of a third monomer if present are the same as or different from each other. Each instance of the first monomer, the second monomer, and the third monomer if present, is different from each other (e.g., each instance of the first monomer is different from each instance of the second monomer). Any two instances of a moiety that appears two or more times may be the same as or different from each other.

In order that the present disclosure may be more fully understood, the following examples are set forth. The synthetic and biological examples described in this application are offered to illustrate the compounds, compositions, and methods provided herein and are not to be construed in any way as limiting their scope.

### BRIEF DESCRIPTION OF THE DRAWINGS

FIG. 1 shows exemplary analytical data of Example 1.

FIG. 2 shows exemplary analytical data of Example 3.

FIG. 3 shows exemplary analytical data of Example 4.

FIG. 4 shows exemplary analytical data of Example 5.

FIG. 5 shows an exemplary 1H NMR spectrum of

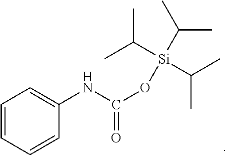 [SMILES: CC(C)[Si](OC(=O)Nc1ccccc1)(C(C)C)C(C)C]

### See Example 6.

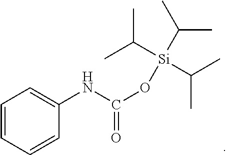 [SMILES: CC(C)[Si](OC(=O)Nc1ccccc1)(C(C)C)C(C)C]

FIG. 6 shows an exemplary mass spectrum of See Example 6.

FIG. 7 shows exemplary images of the polymers of Example 7. “cat.”: catalyst.

FIG. 8 shows exemplary analytical data of PDMS+catalyst of Example 7.

FIG. 9 shows exemplary analytical data of PDMS+MDI of Example 7.

FIG. 10 shows exemplary analytical data of PDMS+HDI of Example 7.

FIG. 11 shows an exemplary image of the hydroxy-terminated PDMS networks of Example 8.

FIG. 12 shows exemplary images of the hydroxy-terminated PDMS networks of Example 8 in toluene or after treatment of 5% AcOH in toluene.

### DETAILED DESCRIPTION OF CERTAIN EMBODIMENTS OF THE DISCLOSURE

### Polymers

In one aspect, the present disclosure provides polymer, wherein the polymer comprises n12 instances of a moiety of Formula (I):

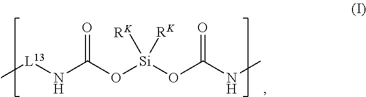

or a salt thereof, wherein:
each instance of R^{K} is independently hydrogen, halogen, substituted or unsubstituted, C₁₋₁₀ alkyl, substituted or unsubstituted, C₂₋₁₀ alkenyl, substituted or unsubstituted, C₂₋₁₀ alkynyl, -L^{K}-(substituted or unsubstituted carbocyclyl), -L^{K}-(substituted or unsubstituted heterocyclyl), -L^{K}-(substituted or unsubstituted aryl), -L^{K}-(substituted or unsubstituted heteroaryl), or —OR^{N};
each instance of L^{K} is independently a single bond, —O—, substituted or unsubstituted, C₁₋₁₀ alkylene, substituted or unsubstituted, C₂₋₁₀ heteroalkylene, substituted or unsubstituted carbocyclylene, substituted or unsubstituted heterocyclylene, substituted or unsubstituted arylene, substituted or unsubstituted heteroarylene, or a combination thereof;
each instance of R^{N} is independently hydrogen, substituted or unsubstituted acyl, substituted or unsubstituted, C₁₋₁₀ alkyl, substituted or unsubstituted carbocyclyl, substituted or unsubstituted heterocyclyl, substituted or unsubstituted aryl, substituted or unsubstituted heteroaryl, or an oxygen protecting group;
or two instances of R^{K} are joined with the intervening atom to form substituted or unsubstituted heterocyclyl;
each instance of L¹³ is a linker, wherein no instance of the linker is a bond or unsubstituted naphthalene diradical; and
n12 is an integer between 1 and 1,000, inclusive.

In another aspect, the present disclosure provides a polymer prepared by a method described herein.

In certain embodiments, at least one instance is each instance.

In certain embodiments, at least one instance of L¹³ is independently substituted or unsubstituted, C₂₋₁₀₀₀ alkylene, substituted or unsubstituted, C₂₋₁₀₀₀ alkenylene, substituted or unsubstituted, C₂₋₁₀₀₀ alkynylene, substituted or unsubstituted, C₂₋₁₀₀₀ heteroalkylene, substituted or unsubstituted, C₂₋₁₀₀₀ heteroalkenylene, or substituted or unsubstituted, C₂₋₁₀₀₀ heteroalkynylene;

optionally one or more carbon atoms in each instance of the substituted or unsubstituted, C₂₋₁₀₀₀ alkylene, substituted or unsubstituted, C₂₋₁₀₀₀ alkenylene, substituted or unsubstituted, C₂₋₁₀₀₀ alkynylene, substituted or unsubstituted, C₂₋₁₀₀₀ heteroalkylene, substituted or unsubstituted, C₂₋₁₀₀₀ heteroalkenylene, and substituted or unsubstituted, C₂₋₁₀₀₀ heteroalkynylene are independently replaced with substituted or unsubstituted carbocyclylene, substituted or unsubstituted heterocyclylene, substituted or unsubstituted arylene, or substituted or unsubstituted heteroarylene.

In certain embodiments, at least one instance of L¹³ is independently substituted or unsubstituted, C₂₋₂₀ alkylene, substituted or unsubstituted, C₂₋₂₀ alkenylene, substituted or unsubstituted, C₂₋₂₀ alkynylene, substituted or unsubstituted, C₂₋₂₀ heteroalkylene, substituted or unsubstituted, C₂₋₂₀ heteroalkenylene, or substituted or unsubstituted, C₂₋₂₀ heteroalkynylene;
optionally one or more carbon atoms in each instance of the substituted or unsubstituted, C₂₋₂₀ alkylene, substituted or unsubstituted, C₂₋₂₀ alkenylene, substituted or unsubstituted, C₂₋₂₀ alkynylene, substituted or unsubstituted, C₂₋₂₀ heteroalkylene, substituted or unsubstituted, C₂₋₂₀ heteroalkenylene, and substituted or unsubstituted, C₂₋₂₀ heteroalkynylene are independently replaced with substituted or unsubstituted carbocyclylene, substituted or unsubstituted heterocyclylene, substituted or unsubstituted arylene, or substituted or unsubstituted heteroarylene.

In certain embodiments, at least one instance of L¹³ is independently substituted or unsubstituted, C₂₋₂₀ alkylene or substituted or unsubstituted, C₂₋₂₀ heteroalkylene, optionally one or more carbon atoms in each instance of the substituted or unsubstituted, C₂₋₂₀ alkylene or substituted or unsubstituted, C₂₋₂₀ heteroalkylene are independently replaced with substituted or unsubstituted carbocyclylene or substituted or unsubstituted heterocyclylene.

In certain embodiments, at least one instance of L¹³ comprises in the backbone of L¹³ one or more instances of -(substituted or unsubstituted nitrogen atom)-C(═O)—O—, one or more instances of —O—C(═O)-(substituted or unsubstituted nitrogen atom)-, one or more instances of -(substituted or unsubstituted nitrogen atom)-C(═O)-(substituted or unsubstituted nitrogen atom)-, one or more instances of —C(═O)—O—, one or more instances of —O—C(═O)—, one or more instances of —C(═O)-(substituted or unsubstituted nitrogen atom)-, one or more instances of -(substituted or unsubstituted nitrogen atom)-C(═O)—, and/or one or more instances of -(substituted or unsubstituted carbon atom)-O-(substituted or unsubstituted carbon atom)-, optionally as repeating units.

In certain embodiments, at least one instance, e.g., between 2 and 10, between 11 and 30, between 30 and 100, between 100 and 300, or between 300 and 1,000, inclusive, instances, of L¹³ comprises in the backbone of L¹³ one or more, e.g., between 2 and 10, between 11 and 30, between 30 and 100, between 100 and 300, or between 300 and 1,000, inclusive, instances of —NH—C(═O)—O— and/or one or more, e.g., between 2 and 10, between 11 and 30, between 30 and 100, between 100 and 300, or between 300 and 1,000, inclusive, instances of —O—C(═O)—NH—, optionally as repeating units.

In certain embodiments, at least one instance, e.g., between 2 and 10, between 11 and 30, between 30 and 100, between 100 and 300, or between 300 and 1,000, inclusive, instances, of L¹³ comprises in the backbone of L¹³ one or more, e.g., between 2 and 10, between 11 and 30, between 30 and 100, between 100 and 300, or between 300 and 1,000, inclusive, instances of —NH—C(═O)—NH—, optionally as repeating units.

In certain embodiments, at least one instance, e.g., between 2 and 10, between 11 and 30, between 30 and 100, between 100 and 300, or between 300 and 1,000, inclusive, instances, of L¹³ comprises in the backbone of L¹³:
at least one instance, e.g., between 2 and 10, between 11 and 30, between 30 and 100, between 100 and 300, or between 300 and 1,000, inclusive, instances, of —NH—C(═O)—NH—, optionally as repeating units; and
at least one instance, e.g., between 2 and 10, between 11 and 30, between 30 and 100, between 100 and 300, or between 300 and 1,000, inclusive, instances, of —NH—C(═O)—O— and/or at least one instance, e.g., between 2 and 10, between 11 and 30, between 30 and 100, between 100 and 300, or between 300 and 1,000, inclusive, instances, of —O—C(═O)—NH—, optionally as repeating units.

In certain embodiments, at least one instance of L¹³ is of the formula:

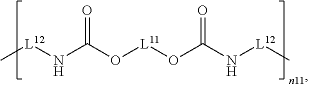

each instance of L¹¹ and L¹² is independently substituted or unsubstituted, C₂₋₁₀₀₀ alkylene, substituted or unsubstituted, C₂₋₁₀₀₀ alkenylene, substituted or unsubstituted, C₂₋₁₀₀₀ alkynylene, substituted or unsubstituted, C₂₋₁₀₀₀ heteroalkylene, substituted or unsubstituted, C₂₋₁₀₀₀ heteroalkenylene, or substituted or unsubstituted, C₂₋₁₀₀₀ heteroalkynylene;
optionally one or more carbon atoms in each instance of the substituted or unsubstituted, C₂₋₁₀₀₀ alkylene, substituted or unsubstituted, C₂₋₁₀₀₀ alkenylene, substituted or unsubstituted, C₂₋₁₀₀₀ alkynylene, substituted or unsubstituted, C₂₋₁₀₀₀ heteroalkylene, substituted or unsubstituted, C₂₋₁₀₀₀ heteroalkenylene, and substituted or unsubstituted, C₂₋₁₀₀₀ heteroalkynylene are independently replaced with substituted or unsubstituted carbocyclylene, substituted or unsubstituted heterocyclylene, substituted or unsubstituted arylene, or substituted or unsubstituted heteroarylene; and
each instance of n11 is independently an integer between 1 and 1,000, inclusive.

In certain embodiments, each instance of L¹¹ and L¹² does not comprise an —OH or —NCO group.

In certain embodiments, at least one instance of the polyisocyanate comprises only two-NCO groups.

In certain embodiments, at least one instance of the polyisocyanate is hexamethylene diisocyanate, isophorone diisocyanate, or 4,4′-diisocyanato dicyclohexylmethane, or a solvate thereof.

In certain embodiments, at least one instance of the polyisocyanate comprises only three-NCO groups.

In certain embodiments, at least one instance of the polyisocyanate is of the formula:

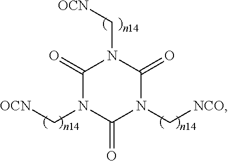

or a solvate thereof, wherein each instance of n14 is independently an integer between 2 and 20, inclusive, e.g., 4, 5, 6, 7, or 8.

In certain embodiments, at least one instance of the polyisocyanate comprises four or more —NCO groups.

In certain embodiments, at least one instance of the silane polyol comprises only two-OH groups.

In certain embodiments, at least one instance of the silane polyol comprises only three-OH groups.

In certain embodiments, at least one instance of the silane polyol comprises four or more —OH groups.

In certain embodiments, one or both instances of R^{K} is/are substituted or unsubstituted, C₁₋₁₀ alkyl.

In certain embodiments, one or both instances of R^{K} is/are —(CH₂)₄₋₁₀—OH. In certain embodiments, one or both instances of R^{K} is/are —(CH₂)₆—OH.

In certain embodiments, one or both instances of R^{K} is/are unsubstituted, C₁₋₆ alkyl.

In certain embodiments, one or both instances of R^{K} is/are unsubstituted isopropyl.

In certain embodiments, one or both instances of R^{K} is/are independently substituted or unsubstituted aryl or -L^{K}-(substituted or unsubstituted aryl).

In certain embodiments, one or both instances of R^{K} is/are independently substituted or unsubstituted phenyl or -L^{K} (substituted or unsubstituted phenyl).

In certain embodiments, one or both instances of R^{K} is/are unsubstituted phenyl.

In certain embodiments, each instance of L¹¹ and L¹² does not comprise an —NH₂ or —NH— group. In certain embodiments, each instance of L¹⁴ does not comprise an —NH₂ or —NH— group.

In certain embodiments, at least one instance of L¹¹ is independently substituted or unsubstituted, C₂₋₁₀₀₀ alkylene or substituted or unsubstituted, C₂₋₁₀₀₀ heteroalkylene.

In certain embodiments, at least one instance of L¹¹ is independently substituted or unsubstituted, C₅₀₋₄₀₀ alkylene or substituted or unsubstituted, C₅₀₋₄₀₀ heteroalkylene.

In certain embodiments, at least one instance of L¹¹ is independently substituted or unsubstituted, C₂₋₄₉ alkylene or substituted or unsubstituted, C₂₋₄₉ heteroalkylene.

In certain embodiments, at least one instance of L¹² is independently substituted or unsubstituted, C₂₋₁₀₀₀ alkylene or substituted or unsubstituted, C₂₋₁₀₀₀ heteroalkylene.

In certain embodiments, at least one instance of L¹² is independently substituted or unsubstituted, C₂₋₁₀₀ alkylene or substituted or unsubstituted, C₂₋₁₀₀ heteroalkylene.

In certain embodiments, the heteroatom(s) within and/or placed at one or more terminal position(s) of the parent chain of at least one instance of the heteroalkylene is/are oxygen.

In certain embodiments, at least one instance of L¹² is independently substituted or unsubstituted, C₂₋₁₂ alkylene.

In certain embodiments, at least one instance of L¹² is unsubstituted n-hexylene.

In certain embodiments, at least one instance of L¹² is

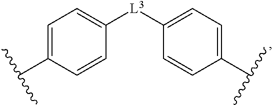

wherein L³ is substituted or unsubstituted alkylene or substituted or unsubstituted heteroalkylene, optionally wherein one, two, or three backbone carbon atoms of the alkylene or heteroalkylene are independently replaced with substituted or unsubstituted heterocyclylene, as valency permits.

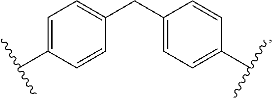 [SMILES: *c1ccc(Cc2ccc(*)cc2)cc1]

In certain embodiments, at least one instance of L¹² is

In certain embodiments, at least one instance of L³ is a single bond. In certain embodiments, at least one instance of L³ is substituted or unsubstituted alkylene or substituted or unsubstituted heteroalkylene, wherein zero or more (e.g., one or two) backbone carbon atoms of the alkylene or heteroalkylene are replaced with substituted or unsubstituted heterocyclylene, as valency permits. In certain embodiments, at least one instance of L³ is substituted or unsubstituted alkylene. In certain embodiments, at least one instance of L³ is —CH₂—, —(CH₂)₂—, —(CH₂)₃—, —(CH₂)₄—, —(CH₂)₅—, or —(CH₂)₆—.

In certain embodiments, at least one instance of n11 is 1.

In certain embodiments, at least one instance of n11 is an integer between 2 and 4, between 4 and 6, or between 7 and 10, inclusive.

In certain embodiments, at least one instance of n11 is an integer between 11 and 30, between 30 and 100, between 100 and 300, or between 300 and 1,000, inclusive.

In certain embodiments, the number-average molecular weight of the polyisocyanate as determined by gel permeation chromatography is between 100 Da and 300 Da, between 300 Da and 1 kDa, between 1 kDa and 3 kDa, between 3 kDa and 10 kDa, between 10 kDa and 30 kDa, or between 30 kDa and 100 kDa, inclusive.

In certain embodiments, the dispersity of the polyisocyanate is between 1 and 1.2, between 1.2 and 1.5, between 1.5 and 1.7, between 1.7 and 2, between 2 and 2.5, between 2.5 and 3, between 3 and 4, or between 4 and 5, inclusive.

In certain embodiments, at least one instance of n12 is 1.

In certain embodiments, at least one instance of n12 is an integer between 2 and 4, between 4 and 6, or between 7 and 10, inclusive.

In certain embodiments, n12 is an integer between 11 and 30, between 30 and 100, between 100 and 300, or between 300 and 1,000, inclusive.

In certain embodiments, n13 instances of the moiety of Formula (I) together are of the formula:

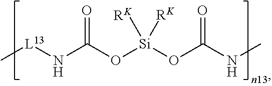

or salt thereof, wherein n13 is an integer between 2 and 1,000, inclusive.

In certain embodiments, at least one instance of n13 is an integer between 2 and 4, between 4 and 6, or between 7 and 10, inclusive.

In certain embodiments, at least one instance of n13 is an integer between 11 and 30, between 30 and 100, between 100 and 300, or between 300 and 1,000, inclusive.

In certain embodiments, at least one instance of the silane polyol is diphenylsilanediol or diisopropylsilanediol, or a solvate thereof.

In certain embodiments, the equivalent ratio of the one or more instances of the silane polyol to the one or more instances of the polyisocyanate is between 0.03:1 and 0.1:1, between 0.1:1 and 0.3:1, between 0.3:1 and 0.5:1, between 0.5:1 and 0.7:1, between 0.7:1 and 0.9:1, between 0.9:1 and 1:0.9, between 1:0.9 and 1:0.7, between 1:0.7 and 1:0.5, or between 1:0.5 and 1:0.3, inclusive.

In certain embodiments, the equivalent ratio of the one or more instances of the silane polyol to the one or more instances of the polyisocyanate is between 0.95:1 and 1:0.95, inclusive.

In certain embodiments, the equivalent ratio of the one or more instances of the third monomer, if present, to the one or more instances of the polyisocyanate is between 0.03:1 and 0.1:1, between 0.1:1 and 0.3:1, between 0.3:1 and 0.5:1, between 0.5:1 and 0.7:1, between 0.7:1 and 0.9:1, or between 0.9:1 and 1:0.9, between 1:0.9 and 1:0.7, between 1:0.7 and 1:0.5, or between 1:0.5 and 1:0.3, inclusive.

In certain embodiments, the number-average molecular weight of the polymer as determined by gel permeation chromatography is between 3 kDa and 10 kDa, between 10 kDa and 30 kDa, between 30 kDa and 100 kDa, or between 100 kDa and 300 kDa, inclusive.

In certain embodiments, the dispersity of the polymer is between 1 and 1.2, between 1.2 and 1.5, between 1.5 and 1.7, between 1.7 and 2, between 2 and 2.5, between 2.5 and 3, between 3 and 4, or between 4 and 5, inclusive.

In certain embodiments, the dispersity of the polymer is between 2.5 and 3.

In certain embodiments, the polymer is crosslinked, and the crosslinking degree as determined by rheology is between 0.1% and 0.3%, between 0.3% and 1%, between 1% and 3%, between 3% and 10%, between 10% and 20%, or between 20% and 40%, inclusive, mole:mole.

In certain embodiments, the polymer is a random polymer.

In certain embodiments, the polymer comprises one or more pharmaceutical agents, wherein the one or more pharmaceutical agents are covalently attached to the polymer.

### Compositions and Kits

In another aspect, the present disclosure provides a composition comprising:
a polymer described herein; and
optionally an excipient.

In certain embodiments, the composition further comprises one or more antioxidants. The antioxidants may increase the stability (e.g., chemical stability) of the polymer. Exemplary antioxidants include DABCO T-9, DBTDL, tocopherol, butylated hydroxyanisole (BHA), butylated hydroxytoluene (BHT), and cysteine. Additional exemplary antioxidants include alpha tocopherol, ascorbic acid, acorbyl palmitate, butylated hydroxyanisole, butylated hydroxytoluene, monothioglycerol, potassium metabisulfite, propionic acid, propyl gallate, sodium ascorbate, sodium bisulfite, sodium metabisulfite, and sodium sulfite. In certain embodiments, the combined concentration of the antioxidants in the composition is between 0.001% and 5%, inclusive, by weight. In certain embodiments, a first antioxidant is BHA, BHT, tocopherol, or cysteine. In certain embodiments, a first antioxidant is BHA (e.g., a mixture (e.g., a 1:1 (w:w) mixture) of 2-tert-Butyl-4-methoxyphenol and 3-tert-butyl-4-methoxyphenol). In certain embodiments, a first antioxidant is BHT (e.g., 2,6-di-tert-butyl-4-methylphenol). In certain embodiments, a first antioxidant is IRGANOX 1010. In certain embodiments, a first antioxidant is IRGANOX 1098. In certain embodiments, the concentration of the first antioxidant in the composition is between 0.001% and 0.01%, between 0.001% and 0.1%, between 0.01% and 0.1%, between 0.01% and 1%, between 0.1% and 1%, or between 0.1% and 10%, inclusive, by weight. In certain embodiments, the concentration of the first antioxidant in the composition is between 0.05% and 2%, inclusive, by weight. In certain embodiments, the concentration of the first antioxidant in the composition is between 0.01% and 0.25%, or between 0.005% and 0.5%, inclusive, by weight. In certain embodiments, the composition further comprises one antioxidant. In certain embodiments, the composition further comprises two antioxidants (e.g., at a ratio of between 1:0.5 to 1:2 by weight). In certain embodiments, the two antioxidants are IRGANOX 1010 and IRGANOX 1098.

In certain embodiments, at least one of the antioxidants is present in a step of a method of preparing the polymer. In certain embodiments, the silane polyol further comprises one or more antioxidants (e.g., BHT). In certain embodiments, at least one of the antioxidants is add to the polymer after it is prepared.

In certain embodiments, the composition further comprises one or more optical brighteners. In certain embodiments, the combined concentration of the optical brighteners in the composition is between 30 and 100 ppm, between 100 and 300 ppm, between 300 and 1000 ppm, or between 1000 and 3000 ppm, inclusive, by weight. In certain embodiments, at least one of the optical brighteners is UVITEX MES, UVITEX OB, LEUCOPUR EGM, or EASTOBRITE OB-1.

In certain embodiments, the composition further comprises one or more bluing agents. In certain embodiments, the combined concentration of the bluing agents in the composition is between 30 and 100 ppm, between 100 and 300 ppm, between 300 and 1000 ppm, or between 1000 and 3000 ppm, inclusive, by weight. In certain embodiments, at least one of the optical brighteners is ultramarine, Prussian Blue, Crown Blue, or Dolly Blue.

In another aspect, the present disclosure provides a kit comprising:
a polymer or a composition described herein; and
instructions for using the polymer or composition.

In certain embodiments, the kit comprises a first container, wherein the first container comprises the polymer or composition. In some embodiments, the kit further comprises a second container. In certain embodiments, the second container comprises the instructions. In certain embodiments, the second container comprises the first container. In some embodiments, the kit further comprises a third container. In certain embodiments, the third container comprises the excipient. In certain embodiments, the third container comprises the additional agent. In certain embodiments, the second container comprises the third container. In certain embodiments, each of the first, second, and third containers is independently a vial, ampule, bottle, syringe, dispenser package, tube, or box.

### Methods of Preparing a Polymer

In another aspect, the present disclosure provides a method of preparing a polymer comprising reacting:
one or more instances of a silane polyol, wherein each instance of the silane polyol is of Formula (A):

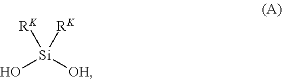

or a salt thereof; and
one or more instances of a polyisocyanate, wherein each instance of the polyisocyanate is of Formula (B):

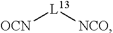

or a salt thereof;
optionally: the step of reacting comprises polymerizing one or more instances of the silane polyol, one or more instances of the polyisocyanate, and optionally one or more instances of a third monomer;
   wherein:
each instance of R^{K} is independently hydrogen, halogen, substituted or unsubstituted, C₁₋₁₀ alkyl, substituted or unsubstituted, C₂₋₁₀ alkenyl, substituted or unsubstituted, C₂₋₁₀ alkynyl, -L^{K}-(substituted or unsubstituted carbocyclyl), -L^{K}-(substituted or unsubstituted heterocyclyl), -L^{K}-(substituted or unsubstituted aryl), -L^{K}-(substituted or unsubstituted heteroaryl), or —OR^{N};
each instance of L^{K} is independently a single bond, —O—, substituted or unsubstituted, C₁₋₁₀ alkylene, substituted or unsubstituted, C₂₋₁₀ heteroalkylene, substituted or unsubstituted carbocyclylene, substituted or unsubstituted heterocyclylene, substituted or unsubstituted arylene, substituted or unsubstituted heteroarylene, or a combination thereof;
each instance of R^{N} is independently hydrogen, substituted or unsubstituted acyl, substituted or unsubstituted, C₁₋₁₀ alkyl, substituted or unsubstituted carbocyclyl, substituted or unsubstituted heterocyclyl, substituted or unsubstituted aryl, substituted or unsubstituted heteroaryl, or an oxygen protecting group;
or two instances of R^{K} are joined with the intervening atom to form substituted or unsubstituted heterocyclyl; and
each instance of L¹³ is independently a linker, wherein no instance of the linker is a bond or unsubstituted naphthalene diradical.

In certain embodiments, the step of reacting one or more instances of a silane polyol, or a salt thereof, and one or more instances of a polyisocyanate further comprises a first temperature and a first time duration. In certain embodiments, the first temperature is between 0 and 10, between 10 and 20, or between 2° and 30° C., inclusive. In certain embodiments, the first temperature is between 30 and 40, between 40 and 60, between 60 and 80, between 80 and 100, or between 10° and 120° C., inclusive. In certain embodiments, the first temperature is substantially constant over the first time duration. In certain embodiments, the first temperature is a variable temperature (e.g., ±5, ±10, ±15, or ±20° C.) over the first time duration.

In certain embodiments, the first time duration is between 1 and 3 hours, between 3 and 8 hours, between 8 and 24 hours, between 1 and 3 days, between 3 and 5 days, or between 5 and 7 days, e.g., between 8 hours and 5 days.

In certain embodiments, the step of reacting one or more instances of a silane polyol, or a salt thereof, and one or more instances of a polyisocyanate further comprises a first solvent. In certain embodiments, the first solvent is substantially one single solvent. In certain embodiments, the first solvent is a mixture of two or more (e.g., three) solvents (e.g., solvents described in this paragraph). In certain embodiments, the first solvent is an organic solvent. In certain embodiments, the first solvent is an aprotic solvent. In certain embodiments, the first solvent is an ether solvent. In certain embodiments, the first solvent is a ketone solvent. In certain embodiments, the first solvent is an alkane solvent. In certain embodiments, the first solvent is an alcohol solvent. In certain embodiments, the first solvent is an aromatic organic solvent. In certain embodiments, the first solvent is benzene, toluene, o-xylene, m-xylene, or p-xylene, or a mixture thereof. In certain embodiments, the first solvent is a non-aromatic organic solvent. In certain embodiments, the first solvent is tetrahydrofuran, dichloromethane, or dioxane, or a mixture thereof. In certain embodiments, the first solvent is tetrahydrofuran. In certain embodiments, the first solvent is methyl tert-butyl ether or 2-methyltetrahydrofuran, or a mixture thereof. In certain embodiments, the first solvent is acetone, acetonitrile, chloroform, diethyl ether, or ethyl acetate, or a mixture thereof. In certain embodiments, the first solvent is an inorganic solvent. In certain embodiments, the boiling point of the first solvent at about 1 atm is between 30 and 50, between 50 and 70, between 70 and 100, between 100 and 130, between 130 and 160, or between 16° and 200° C., inclusive.

Unless otherwise provided, each of the steps of a method described herein is under a pressure between 0.5 and 1.1 atm (e.g., between 0.8 and 1.1 atm).

In certain embodiments, the method further comprises reacting one or more instances of a compound of Formula (B-1):

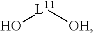

or a salt thereof, with one or more instances of a compound of Formula (B-2):

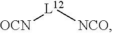

or a salt thereof, to provide the polyisocyanate.

In certain embodiments, the step of reacting the one or more instances of the compound of Formula (B-1), or salt thereof, with the one or more instances of the compound of Formula (B-2), or salt thereof, comprises polymerizing the one or more instances of the compound of Formula (B-1), or salt thereof, with the one or more instances of the compound of Formula (B-2), or salt thereof, optionally in the presence of a polymerization catalyst.

In certain embodiments, the polymerization catalyst is dibutyltin dilaurate, platinum(0)-1,3-divinyl-1,1,3,3-tetramethyldisiloxane, dibutyltin mercaptide, dibutyltin thiocarboxylate, tin (II) 2-ethylhexanoate, sodium carbonate, sodium bicarbonate, potassium carbonate, potassium bicarbonate, calcium carbonate, calcium bicarbonate, tris (acetylacetonato) iron (III), triethylenediamine, 1,4-diazabicyclo[2.2.2]octane, dimethylcyclohexylamine, dimethylethanolamine, or bis-(2-dimethylaminoethyl)ether, or a salt or solvate thereof, or a mixture thereof.

In certain embodiments, the polymerization catalyst is dibutyltin dilaurate or platinum (0)-1,3-divinyl-1,1,3,3-tetramethyldisiloxane, or a solvate thereof.

In certain embodiments, the equivalent ratio of the polymerization catalyst to the one or more instances of the silane polyol is between 1:0.001 and 1:0.003, between 1:0.003 and 1:0.01, between 1:0.01 and 1:0.03, or between 1:0.03 and 1:0.1, inclusive.

In certain embodiments, the equivalent ratio of the one or more instances of the compound of Formula (B-1), or a salt thereof, to the one or more instances of the silane polyol is between 1:0.1 and 1:0.3, between 1:0.3 and 1:0.5, between 1:0.5 and 1:0.7, between 1:0.7 and 1:1, between 1:1 and 1:2, between 1:2 and 1:4, or between 1:4 and 1:10, inclusive.

In certain embodiments, the equivalent ratio of the one or more instances of the compound of Formula (B-1), or a salt thereof, to the one or more instances of the compound of Formula (B-2), or a salt thereof, is between 0.3:1 and 0.5:1, between 0.5:1 and 0.7:1, between 0.7:1 and 0.9:1, or between 0.9:1 and 1:1, inclusive.

In certain embodiments, the equivalent ratio of the one or more instances of the compound of Formula (B-1), or a salt thereof, to the one or more instances of the compound of Formula (B-2), or a salt thereof, is between 0.4:1 and 0.6:1, inclusive.

In certain embodiments, at least one instance of the compound of Formula (B-2) is hexamethylene diisocyanate, or a solvate thereof.

In certain embodiments, at least one instance of the compound of Formula (B-2) is of the formula:

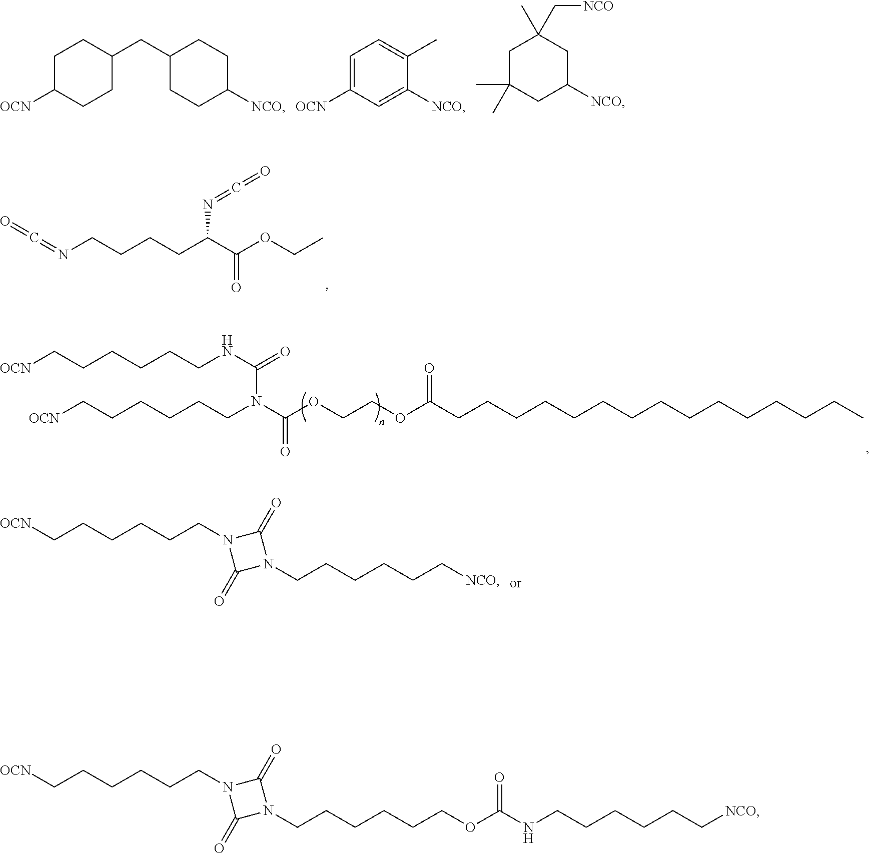

or a solvate thereof.

In certain embodiments, the third monomer is a compound of Formula (B-1):

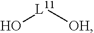

or a salt thereof, wherein:
L¹¹ is substituted or unsubstituted, C₂₋₁₀₀₀ alkylene, substituted or unsubstituted, C₂₋₁₀₀₀ alkenylene, substituted or unsubstituted, C₂₋₁₀₀₀ alkynylene, substituted or unsubstituted, C₂₋₁₀₀₀ heteroalkylene, substituted or unsubstituted, C₂₋₁₀₀₀ heteroalkenylene, or substituted or unsubstituted, C₂₋₁₀₀₀ heteroalkynylene; and
optionally one or more carbon atoms in each instance of the substituted or unsubstituted, C₂₋₁₀₀₀ alkylene, substituted or unsubstituted, C₂₋₁₀₀₀ alkenylene, substituted or unsubstituted, C₂₋₁₀₀₀ alkynylene, substituted or unsubstituted, C₂₋₁₀₀₀ heteroalkylene, substituted or unsubstituted, C₂₋₁₀₀₀ heteroalkenylene, and substituted or unsubstituted, C₂₋₁₀₀₀ heteroalkynylene are independently replaced with substituted or unsubstituted carbocyclylene, substituted or unsubstituted heterocyclylene, substituted or unsubstituted arylene, or substituted or unsubstituted heteroarylene.

In certain embodiments, the third monomer is a crosslinker.

In certain embodiments, the third monomer is a mixture of:
a compound of Formula (B-1), or a salt thereof; and
a crosslinker.

In certain embodiments, at least one instance of the compound of Formula (B-1) is independently of the formula:

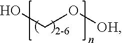

wherein n is an integer between 4 and 20, inclusive.

In certain embodiments, at least one instance of the compound of Formula (B-1) is independently of the formula:

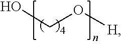

wherein n is an integer between 4 and 20, inclusive.

In certain embodiments, at least one instance of the compound of Formula (B-1) is PLURACOL 1062.

In certain embodiments, the third monomer is a crosslinker comprising only three-OH groups.

In certain embodiments, the third monomer is unsubstituted, branched or unbranched alkane triol.

In certain embodiments, the third monomer is glycerol, or a solvate thereof.

In certain embodiments, the third monomer is a crosslinker comprising four or more-OH groups.

### Methods of Degrading a Polymer

In another aspect, the present disclosure provides a method of degrading a polymer described herein comprising reacting the polymer with an acid or fluoride source under suitable conditions.

In certain embodiments, the method comprises reacting the polymer with the acid under suitable conditions. In certain embodiments, the acid is an aqueous solution of an acid. In certain embodiments, the acid is an inorganic acid. In certain embodiments, the acid is an organic acid. In certain embodiments, the acid has a pKₐ value of less than 3, less than 2, less than 1, or less than 0, under ambient conditions. In certain embodiments, the acid has a pKₐ value of between 0 and 2, between 2 and 4, between 4 and 6, or between 6 and 8, inclusive, under ambient conditions. In certain embodiments, the acid has a pKₐ value of between 3 and 6, inclusive, under ambient conditions. In certain embodiments, the acid is HCl, HBr, HI, HClO₄, HNO₃, H₂SO₄, CH₃SO₃H, or CF₃SO₃H. In certain embodiments, the acid is HCl. In certain embodiments, the acid is unsubstituted C₁₋₆ carboxylic acid. In certain embodiments, the acid is unsubstituted C₇-12 carboxylic acid. In certain embodiments, the acid is CF₃CO₂H. In certain embodiments, the acid is CH₃CO₂H. In certain embodiments, the acid is unsubstituted n-octanoic acid.

In certain embodiments, the fluoride source is tetra (unsubstituted alkyl)-ammonium fluoride. In certain embodiments, the fluoride source is tetra (unsubstituted C₁₋₆ alkyl)-ammonium fluoride (e.g., TBAF). In certain embodiments, the fluoride source is a metal fluoride (e.g., alkali metal fluoride or alkaline earth metal fluoride). In certain embodiments, a polymer is chemically degradable in the presence of tetra-n-butylammonium fluoride (TBAF).

In certain embodiments, the amount of the acid is in excess (e.g., between 3 and 10, between 10 and 30, between 30 and 100, between 100 and 1000, or between 1000 and 10000 fold of the amount of O—Si bonds in the polymer, mol:mol).

In certain embodiments, the amount of the fluoride source is in excess (e.g., between 3 and 10, between 10 and 30, between 30 and 100, between 100 and 1000, or between 1000 and 10000 fold of the amount of O—Si bonds in the polymer, mol:mol).

In certain embodiments, the suitable conditions comprise a second temperature and a second time duration. In certain embodiments, the second temperature is between 30 and 40, between 40 and 60, between 60 and 80, between 80 and 100, or between 10° and 120° C., inclusive. In certain embodiments, the second temperature is between 120 and 140, between 140 and 160, or between 16° and 180° C., inclusive. In certain embodiments, the second temperature is substantially constant over the second time duration. In certain embodiments, the second temperature is a variable temperature (e.g., +5, +10, +15, or +20° C.) over the second time duration.

In certain embodiments, the second time duration is between 1 and 3 hours, between 3 and 8 hours, between 8 and 24 hours, between 1 and 3 days, between 3 and 5 days, or between 5 and 7 days, e.g., between 8 hours and 5 days.

In certain embodiments, the suitable conditions further comprise a second solvent. In certain embodiments, the second solvent is substantially one single solvent. In certain embodiments, the second solvent is a mixture of two or more (e.g., three) solvents (e.g., solvents described in this paragraph). In certain embodiments, the second solvent is an organic solvent. In certain embodiments, the second solvent is an aprotic solvent. In certain embodiments, the second solvent is an ether solvent. In certain embodiments, the second solvent is a ketone solvent. In certain embodiments, the second solvent is an alkane solvent. In certain embodiments, the second solvent is an alcohol solvent. In certain embodiments, the second solvent is an aromatic organic solvent. In certain embodiments, the second solvent is benzene, toluene, o-xylene, m-xylene, or p-xylene, or a mixture thereof. In certain embodiments, the second solvent is toluene In certain embodiments, the second solvent is a non-aromatic organic solvent. In certain embodiments, the second solvent is tetrahydrofuran, dichloromethane, or dioxane, or a mixture thereof. In certain embodiments, the second solvent is tetrahydrofuran. In certain embodiments, the second solvent is methyl tert-butyl ether or 2-methyltetrahydrofuran, or a mixture thereof. In certain embodiments, the second solvent is acetone, acetonitrile, chloroform, diethyl ether, or ethyl acetate, or a mixture thereof. In certain embodiments, the second solvent is an inorganic solvent. In certain embodiments, the boiling point of the second solvent at about 1 atm is between 30 and 50, between 50 and 70, between 70 and 100, between 100 and 130, between 130 and 160, or between 16° and 200° C., inclusive.

In certain embodiments, the suitable conditions are substantially free of a second solvent.

In certain embodiments, the volume ratio between an acid and the second solvent is between 1:0.1 and 1:0.3, between 1:0.3 and 1:1, between 1:1 and 1:3, or between 1:3 and 1:10, inclusive.

Unless otherwise provided, each of the steps of a method described herein is under a pressure between 0.5 and 1.1 atm (e.g., between 0.8 and 1.1 atm).

### EXAMPLES

### Example 1. Preparation of Polymers Using Silanediols

Polymers were prepared according to the method shown in Scheme 1.

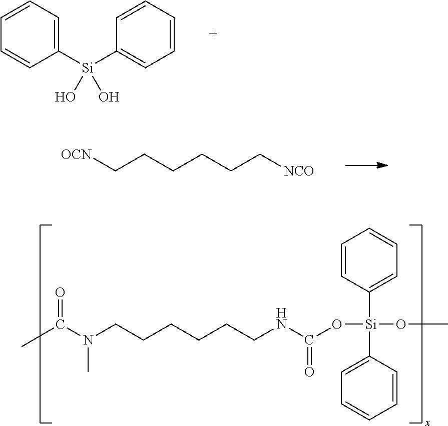

### Scheme 1. Exemplary Preparation of Polymers Using Silanediols

The reaction was performed using 1.0 equivalents of diphenylsilanediol, 1.0 equivalents of hexamethylene diisocyanate, and 0.01 equivalents of dibutyltin dilaurate in anhydrous DMSO at room temperature.

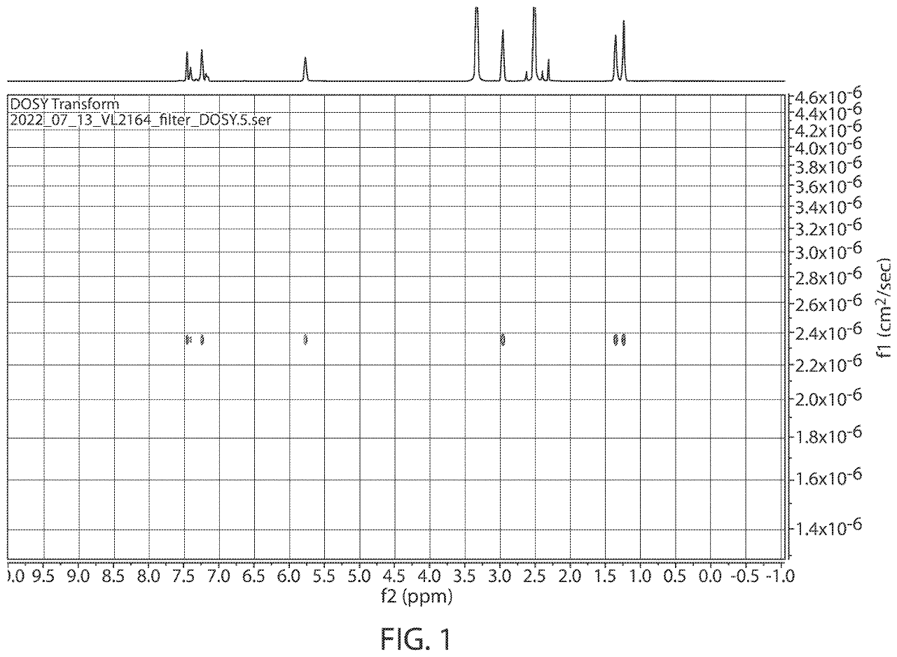

Exemplary analytical data are shown in FIG. 1.

### Example 2. Preparation of Polymers Using Polyisocyanates

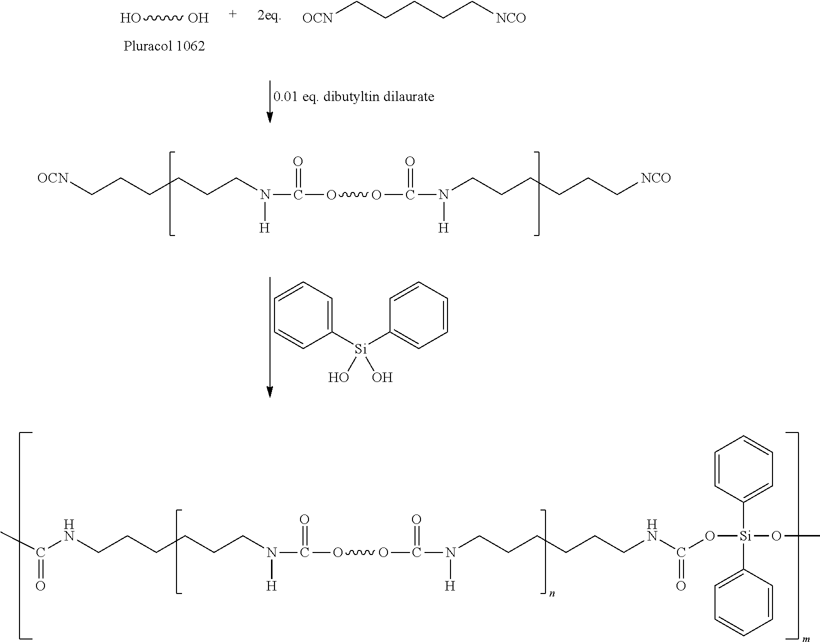

The first reaction step was performed using 1.0 equivalents of Pluracol 1062, 2.0 equivalents of hexamethylene diisocyanate, and 0.01 equivalents of dibutyltin dilaurate neat at room temperature. The product of the first step was the polyisocyanate (Prepolymer).

The second reaction step was performed using 1.0 equivalents of diphenylsilanediol neat or in anhydrous DMF at 80° C. In a preferred embodiment, the second step is performed neat at 80° C.

### Example 3. Preparation of Polyisocyanate (Prepolymer)

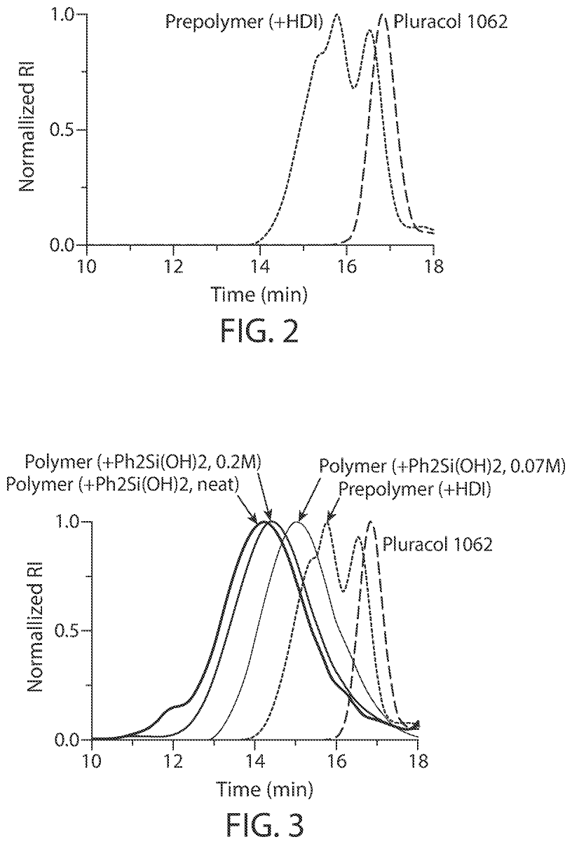

A polyisocyanate was prepared. Exemplary analytical data are shown in FIG. 2.

### Example 4. Incorporation of Silanediol LED to Increase in Molecular Weight

Exemplary analytical data are shown in FIG. 3. Prepolymer: polyisocyanate.

### Example 5. Degradation of Silyl Carbamate Bond with Tetrabutylammonium Fluoride (TBAF)

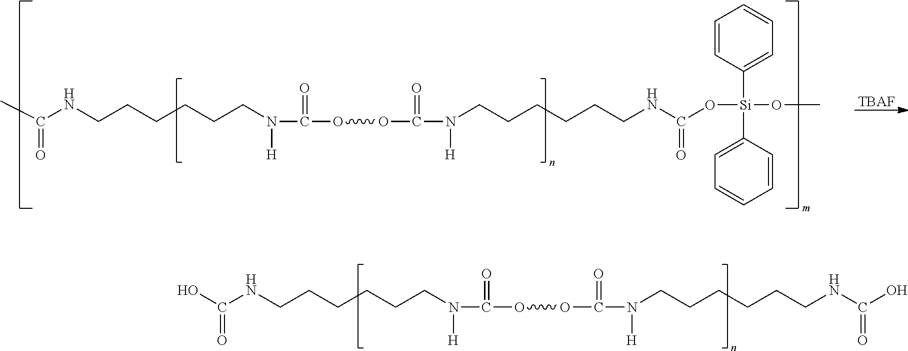

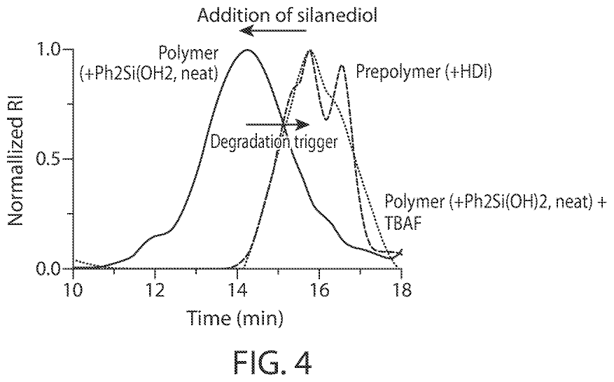

The reaction was performed using 1.0 equivalents of the polymer of Example 2 and excess TBAF (greater than 5.0 equivalents of TBAF) in tetrahydrofuran at room temperature. Exemplary analytical data are shown in FIG. 4.

### Example 6. Direct Coupling of Silanols to Isocyanates

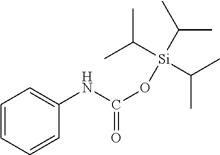 [SMILES: CC(C)[Si](OC(=O)Nc1ccccc1)(C(C)C)C(C)C]

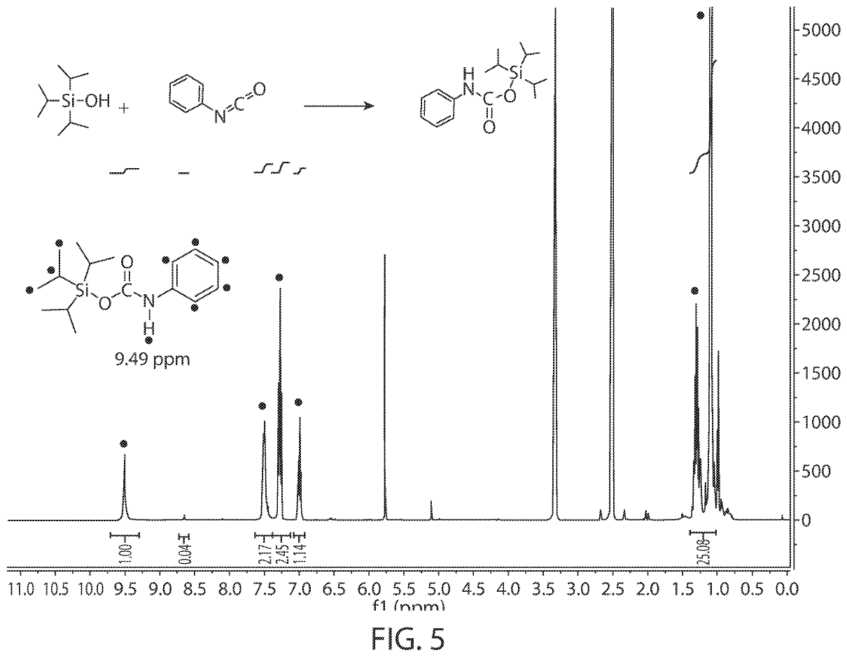

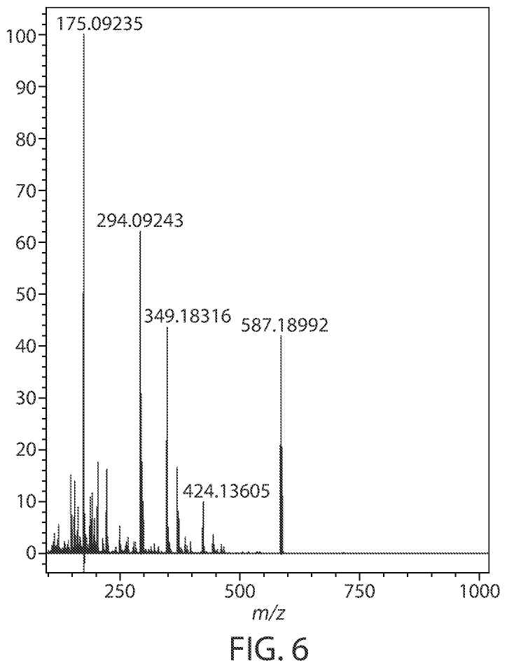

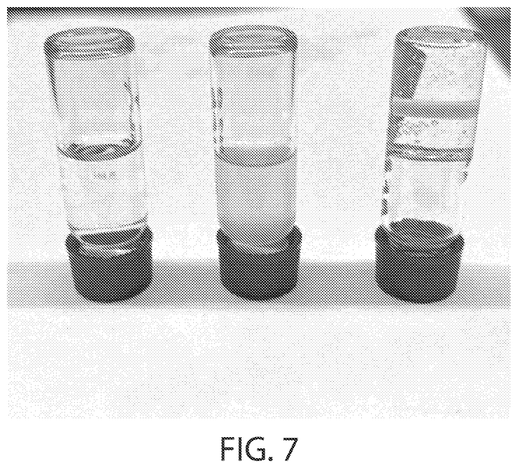

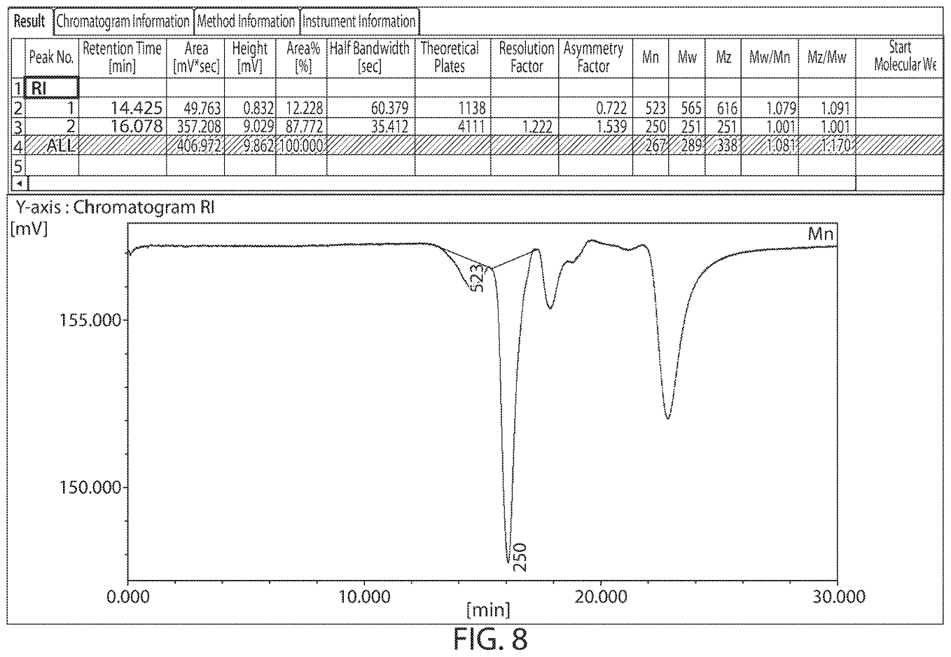

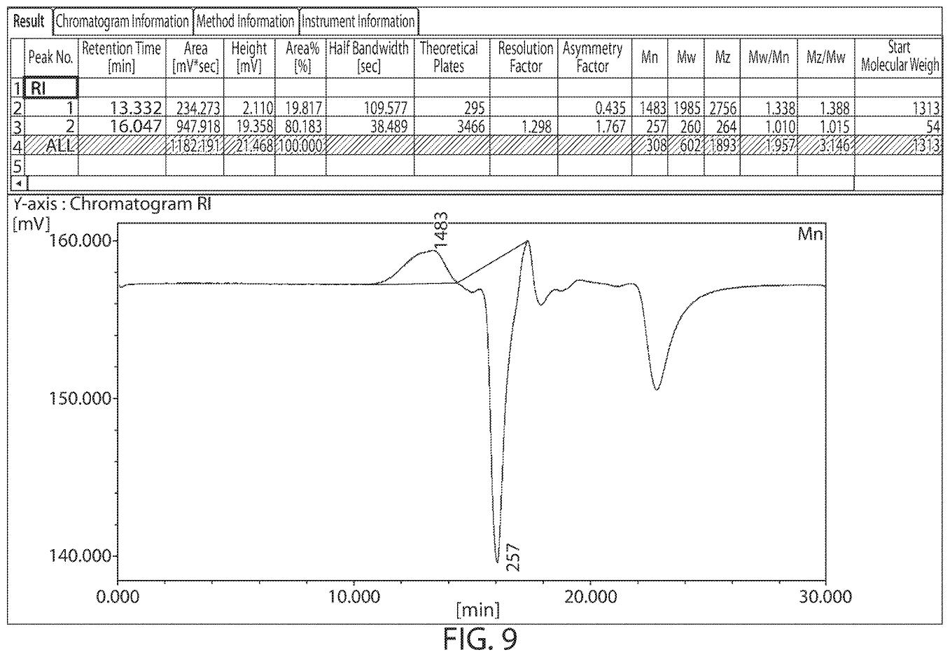

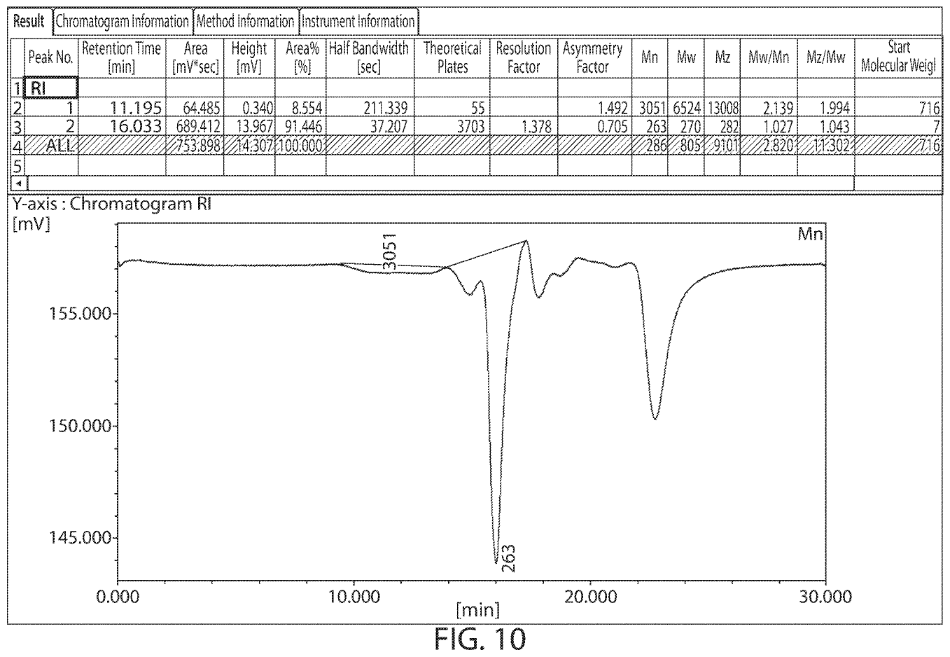

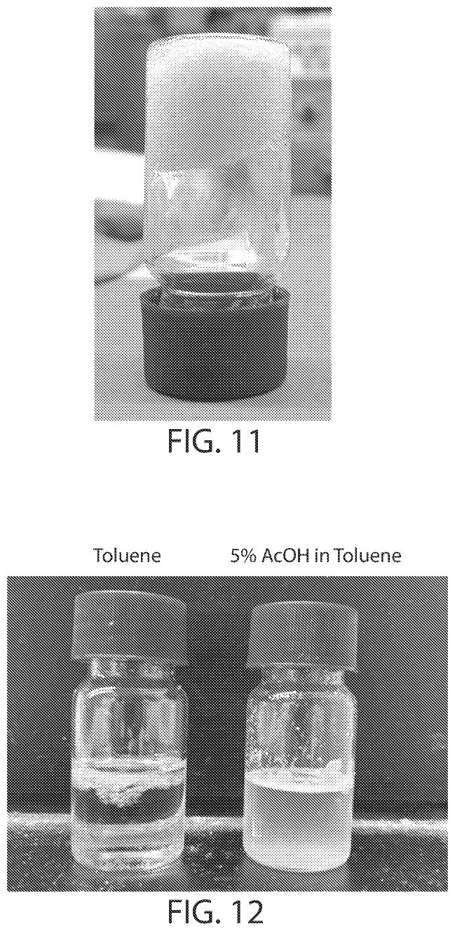

was prepared by a direct coupling of a silanol to an isocyanate according to the method shown in FIG. 5. A 1H NMR spectrum and a mass spectrum of the product are shown in FIG. 5 and FIG. 6, respectively.

### Example 7. Polymerization of Hydroxy Terminated Polydimethylsiloxane (PDMS) and Diisocyantes

A control was prepared according to Scheme 2.

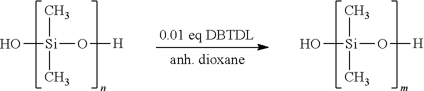

### Scheme 2. Exemplary Preparation of a Control (PDMS+Catalyst).

Hydroxy terminated PDMS and MDI or HDI were polymerized according to the methods shown in Scheme 3. Dibutyltin dilaurate (DBTDL) was used as a catalyst.

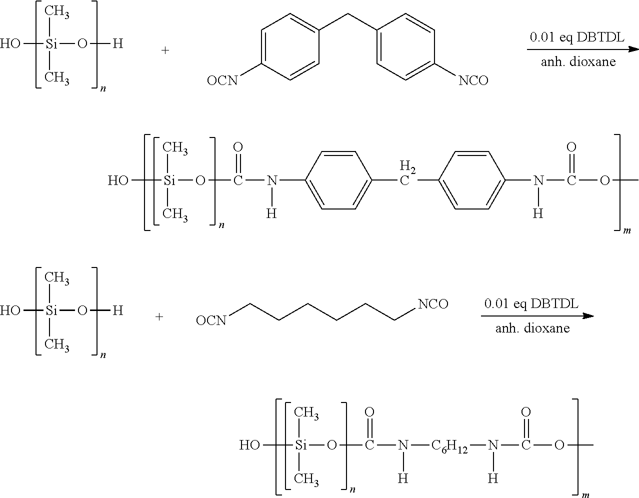

Scheme 3. Exemplary polymerization of hydroxy terminated PDMS and diisocyantes to form polymer PDMS+MDI (top panel) and polymer PDMS+HDI (bottom panel).

In Scheme 2 and Scheme 3, Mₙ of the hydroxy terminated PDMS (

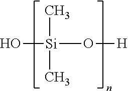

was about 550; “anh.”: anhydrous; and dibutyltin dilaurate (DBTDL) was used as a catalyst.

Exemplary images of the products are shown in FIG. 7.

Exemplary analytical data are shown in FIG. 8 (PDMS+catalyst), FIG. 9 (PDMS+MDI), and FIG. 10 (PDMS+HDI).

### Example 8. Degradation of Hydroxy-Terminated PDMS Networks with Acetic Acid

Hydroxy-terminated PDMS networks were prepared according to the methods shown in Scheme 4. An exemplary image of the hydroxy-terminated PDMS networks is shown in FIG. 11.

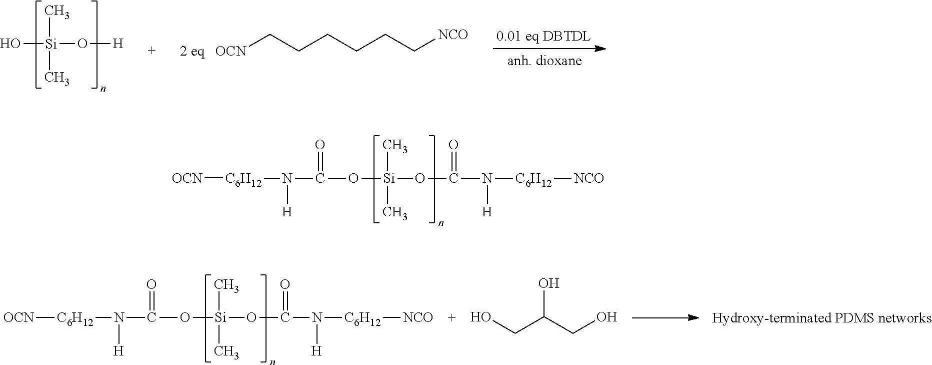

### Scheme 4. Exemplary Preparation of Hydroxy-Terminated PDMS Networks.

The hydroxy-terminated PDMS networks degraded after treatment with 5% AcOH in toluene (FIG. 12).

### EQUIVALENTS AND SCOPE

In the claims articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention includes embodiments in which more than one, or all of the group members are present in, employed in, or otherwise relevant to a given product or process.

Furthermore, the invention encompasses all variations, combinations, and permutations in which one or more limitations, elements, clauses, and descriptive terms from one or more of the listed claims is introduced into another claim. For example, any claim that is dependent on another claim can be modified to include one or more limitations found in any other claim that is dependent on the same base claim. Where elements are presented as lists, e.g., in Markush group format, each subgroup of the elements is also disclosed, and any element(s) can be removed from the group. It should it be understood that, in general, where the invention, or aspects of the invention, is/are referred to as comprising particular elements and/or features, certain embodiments of the invention or aspects of the invention consist, or consist essentially of, such elements and/or features. For purposes of simplicity, those embodiments have not been specifically set forth in haec verba herein. It is also noted that the terms “comprising” and “containing” are intended to be open and permits the inclusion of additional elements or steps. Where ranges are given, endpoints are included. Furthermore, unless otherwise indicated or otherwise evident from the context and understanding of one of ordinary skill in the art, values that are expressed as ranges can assume any specific value or sub-range within the stated ranges in different embodiments of the invention, to the tenth of the unit of the lower limit of the range, unless the context clearly dictates otherwise.

This application refers to various issued patents, published patent applications, journal articles, and other publications, all of which are incorporated herein by reference. If there is a conflict between any of the incorporated references and the instant specification, the specification shall control. In addition, any particular embodiment of the present invention that falls within the prior art may be explicitly excluded from any one or more of the claims. Because such embodiments are deemed to be known to one of ordinary skill in the art, they may be excluded even if the exclusion is not set forth explicitly herein. Any particular embodiment of the invention can be excluded from any claim, for any reason, whether or not related to the existence of prior art.

Those skilled in the art will recognize or be able to ascertain using no more than routine experimentation many equivalents to the specific embodiments described herein. The scope of the present embodiments described herein is not intended to be limited to the above Description, but rather is as set forth in the appended claims. Those of ordinary skill in the art will appreciate that various changes and modifications to this description may be made without departing from the spirit or scope of the present invention, as defined in the following claims.

1. A polymer, wherein the polymer comprises n12 instances of a moiety of Formula (I): 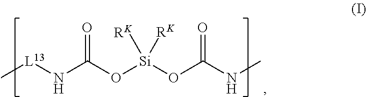
or a salt thereof, wherein:
each instance of R^{K} is independently hydrogen, halogen, substituted or unsubstituted, C₁₋₁₀ alkyl, substituted or unsubstituted, C₂₋₁₀ alkenyl, substituted or unsubstituted, C₂₋₁₀ alkynyl, -L^{K}-(substituted or unsubstituted carbocyclyl), -L^{K}-(substituted or unsubstituted heterocyclyl), -L^{K}-(substituted or unsubstituted aryl), -L^{K}-(substituted or unsubstituted heteroaryl), or —OR^{N};
each instance of L^{K} is independently a single bond, —O—, substituted or unsubstituted, C₁₋₁₀ alkylene, substituted or unsubstituted, C₂₋₁₀ heteroalkylene, substituted or unsubstituted carbocyclylene, substituted or unsubstituted heterocyclylene, substituted or unsubstituted arylene, substituted or unsubstituted heteroarylene, or a combination thereof;
each instance of R^{N} is independently hydrogen, substituted or unsubstituted acyl, substituted or unsubstituted, C₁₋₁₀ alkyl, substituted or unsubstituted carbocyclyl, substituted or unsubstituted heterocyclyl, substituted or unsubstituted aryl, substituted or unsubstituted heteroaryl, or an oxygen protecting group;
or two instances of R^{K} are joined with the intervening atom to form substituted or unsubstituted heterocyclyl;
each instance of L¹³ is a linker, wherein no instance of the linker is a bond or unsubstituted naphthalene diradical; and
n12 is an integer between 1 and 1,000, inclusive.

2. A method of preparing a polymer comprising reacting:
one or more instances of a silane polyol, wherein each instance of the silane polyol is of Formula (A): 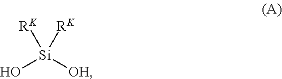
or a salt thereof; and
one or more instances of a polyisocyanate, wherein each instance of the polyisocyanate is of Formula (B): 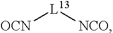
or a salt thereof;
optionally: the step of reacting comprises polymerizing one or more instances of the silane polyol, one or more instances of the polyisocyanate, and optionally one or more instances of a third monomer;
wherein:
each instance of R^{K} is independently hydrogen, halogen, substituted or unsubstituted, C₁₋₁₀ alkyl, substituted or unsubstituted, C₂₋₁₀ alkenyl, substituted or unsubstituted, C₂₋₁₀ alkynyl, -L^{K}-(substituted or unsubstituted carbocyclyl), -L^{K}-(substituted or unsubstituted heterocyclyl), -L^{K}-(substituted or unsubstituted aryl), -L^{K}-(substituted or unsubstituted heteroaryl), or —OR^{N};
each instance of L^{K} is independently a single bond, —O—, substituted or unsubstituted, C₁₋₁₀ alkylene, substituted or unsubstituted, C₂₋₁₀ heteroalkylene, substituted or unsubstituted carbocyclylene, substituted or unsubstituted heterocyclylene, substituted or unsubstituted arylene, substituted or unsubstituted heteroarylene, or a combination thereof;
each instance of R^{N} is independently hydrogen, substituted or unsubstituted acyl, substituted or unsubstituted, C₁₋₁₀ alkyl, substituted or unsubstituted carbocyclyl, substituted or unsubstituted heterocyclyl, substituted or unsubstituted aryl, substituted or unsubstituted heteroaryl, or an oxygen protecting group;
or two instances of R^{K} are joined with the intervening atom to form substituted or unsubstituted heterocyclyl; and
each instance of L¹³ is independently a linker, wherein no instance of the linker is a bond or unsubstituted naphthalene diradical.

3. The polymer of claim 1, wherein at least one instance of L¹³ is independently substituted or unsubstituted, C₂₋₁₀₀₀ alkylene, substituted or unsubstituted, C₂₋₁₀₀₀ alkenylene, substituted or unsubstituted, C₂₋₁₀₀₀ alkynylene, substituted or unsubstituted, C₂₋₁₀₀₀ heteroalkylene, substituted or unsubstituted, C₂₋₁₀₀₀ heteroalkenylene, or substituted or unsubstituted, C₂₋₁₀₀₀ heteroalkynylene;
optionally one or more carbon atoms in each instance of the substituted or unsubstituted, C₂₋₁₀₀₀ alkylene, substituted or unsubstituted, C₂₋₁₀₀₀ alkenylene, substituted or unsubstituted, C₂₋₁₀₀₀ alkynylene, substituted or unsubstituted, C₂₋₁₀₀₀ heteroalkylene, substituted or unsubstituted, C₂₋₁₀₀₀ heteroalkenylene, and substituted or unsubstituted, C₂₋₁₀₀₀ heteroalkynylene are independently replaced with substituted or unsubstituted carbocyclylene, substituted or unsubstituted heterocyclylene, substituted or unsubstituted arylene, or substituted or unsubstituted heteroarylene.

4-5. (canceled)

6. The polymer of claim 1, wherein at least one instance of L¹³ comprises in the backbone of L¹³ one or more instances of -(substituted or unsubstituted nitrogen atom)-C(═O)—O—, one or more instances of —O—C(═O)-(substituted or unsubstituted nitrogen atom)-, one or more instances of -(substituted or unsubstituted nitrogen atom)-C(═O)-(substituted or unsubstituted nitrogen atom)-, one or more instances of —C(═O)—O—, one or more instances of —O—C(═O)—, one or more instances of —C(═O)-(substituted or unsubstituted nitrogen atom)-, one or more instances of -(substituted or unsubstituted nitrogen atom)-C(═O)—, and/or one or more instances of -(substituted or unsubstituted carbon atom)-O-(substituted or unsubstituted carbon atom)-, optionally as repeating units.

7-9. (canceled)

10. The polymer of claim 1, wherein at least one instance of L¹³ is of the formula: 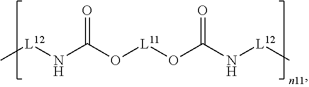
each instance of L¹¹ and L¹² is independently substituted or unsubstituted, C₂₋₁₀₀₀ alkylene, substituted or unsubstituted, C₂₋₁₀₀₀ alkenylene, substituted or unsubstituted, C₂₋₁₀₀₀ alkynylene, substituted or unsubstituted, C₂₋₁₀₀₀ heteroalkylene, substituted or unsubstituted, C₂₋₁₀₀₀ heteroalkenylene, or substituted or unsubstituted, C₂₋₁₀₀₀ heteroalkynylene;
optionally one or more carbon atoms in each instance of the substituted or unsubstituted, C₂₋₁₀₀₀ alkylene, substituted or unsubstituted, C₂₋₁₀₀₀ alkenylene, substituted or unsubstituted, C₂₋₁₀₀₀ alkynylene, substituted or unsubstituted, C₂₋₁₀₀₀ heteroalkylene, substituted or unsubstituted, C₂₋₁₀₀₀ heteroalkenylene, and substituted or unsubstituted, C₂₋₁₀₀₀ heteroalkynylene are independently replaced with substituted or unsubstituted carbocyclylene, substituted or unsubstituted heterocyclylene, substituted or unsubstituted arylene, or substituted or unsubstituted heteroarylene;
each instance of n11 is independently an integer between 1 and 1,000, inclusive;

11-20. (canceled)

21. A polymer prepared by the method of claim 2.

22-40. (canceled)

41. The polymer of claim 1, wherein one or both instances of R^{K} is/are substituted or unsubstituted, C₁₋₁₀ alkyl.

42-45. (canceled)

46. The polymer of claim 1, wherein one or both instances of R^{K} is/are independently substituted or unsubstituted phenyl or -L^{K} (substituted or unsubstituted phenyl).

47-60. (canceled)

61. The polymer of claim 1, wherein the number-average molecular weight of the polyisocyanate as determined by gel permeation chromatography is between 100 Da and 300 Da, between 300 Da and 1 kDa, between 1 kDa and 3 kDa, between 3 kDa and 10 kDa, between 10 kDa and 30 kDa, or between 30 kDa and 100 kDa, inclusive.

62-63. (canceled)

64. The polymer of claim 1, wherein at least one instance of n12 is an integer between 2 and 4, between 4 and 6, or between 7 and 10, inclusive.

65. The polymer of claim 1, wherein n12 is an integer between 11 and 30, between 30 and 100, between 100 and 300, or between 300 and 1,000, inclusive.

66. The polymer of claim 1, wherein n13 instances of the moiety of Formula (I) together are of the formula: 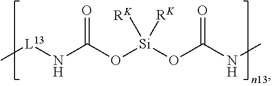
or salt thereof, wherein n13 is an integer between 2 and 1,000, inclusive.

67-72. (canceled)

73. The polymer of claim 1, wherein the number-average molecular weight of the polymer as determined by gel permeation chromatography is between 3 kDa and 10 kDa, between 10 kDa and 30 kDa, between 30 kDa and 100 kDa, or between 100 kDa and 300 kDa, inclusive.

74-75. (canceled)

76. The polymer of claim 1, wherein the polymer is crosslinked, and the crosslinking degree as determined by rheology is between 0.1% and 0.3%, between 0.3% and 1%, between 1% and 3%, between 3% and 10%, between 10% and 20%, or between 20% and 40%, inclusive, mole:mole.

77-78. (canceled)

79. A composition comprising:
a polymer of claim 1; and
optionally an excipient.

80. A kit comprising:
a polymer of claim 1; and
instructions for using the polymer.

81. A method of degrading a polymer of claim 1 comprising reacting the polymer with an acid or fluoride source under suitable conditions.

82-87. (canceled)

88. A composition comprising:
a polymer of claim 21; and
optionally an excipient.

89. A kit comprising:
a polymer of claim 21; and
instructions for using the polymer.

90. A method of degrading a polymer of claim 21 comprising reacting the polymer with an acid or fluoride source under suitable conditions.
